(19) United States
(12) Patent Application Publication
(10) Pub. No.: US 2008/0033759 A1
(43) Pub. Date: Feb. 7, 2008

(54) INFORMATION MANAGER FOR A PROCEDURE-BASED MEDICAL PRACTICE

(75) Inventor: David J. Finlay, St. Louis, MO (US)

Correspondence Address: SENNIGER POWERS, ONE METROPOLITAN SQUARE, 16TH FLOOR, ST LOUIS, MO, 63102, US

(73) Assignee: VASTRAC, INC., St. Louis, MO (US)

(21) Appl. No.: 11/461,955

(22) Filed: Aug. 2, 2006

(51) Int. Cl. G06F 19/00

(52) U.S. Cl. 705/3

(57) ABSTRACT

A computer-implemented method for managing information in a procedure-based medical practice. Patient data relating to a plurality of patients is maintained in a memory area. A patient-specific user interface is presented to a user for collecting procedure-planning data relating to one or more planned medical procedures for a selected patient. Another patient-specific user interface is presented to the user for collecting post-procedure execution data relating to one or more of the planned medical procedures after being performed in the procedure-based medical practice. A further patient-specific user interface for collecting post-procedure execution billing data and post-procedure equipment billing data is presented to the user.

### BACKGROUND

Medical practices are complex entities that must collect, manage, store, and readily retrieve large amounts of patient data. Traditionally, such practices maintained patient data in paper medical charts. Paper medical charts are inexpensive and are fairly efficient at data collection. Paper charts, however, suffer from obvious drawbacks, including storage expense, lack of searching capability, possibility of loss, and concentration of information concerns. Also conventionally, electronic data collection systems are available as an alternative to paper charts. These electronic collection systems offer some advantages over paper charts, including efficient data collection via a computer interface, ability to pre-fill data fields from stored data, multiple access points for patient data (e.g., multiple terminals for access via a network), and ability to regularly back-up the medical data.

Although such electronic collection systems offer some benefits, they fail to integrate several data management functions of a medical practice. For example, in a procedure-based medical practice, such as a surgery center, additional data management functions are important, such as accurately billing for particular procedures performed, tracking patient exposure to procedural materials, tracking prior patient procedures, tracking procedure outcomes and complications, and allowing searching of all practice data. In a practice where common procedures require multiple steps, recordation and billing for each step to receive proper payment is important. Thus, a system for tracking and accurately coding each of such procedures to match with the billing process is important. Moreover, the integration of such functions, as well as patient charting, into a single information manager capable of sharing data would be useful. Moreover, the joining of such billing, patient, and procedural information with a common search platform would provide a beneficial searching tool.

### SUMMARY

The following simplified summary provides a basic overview of some aspects of the present technology. This summary is not an extensive overview. It is not intended to identify key or critical elements or to delineate the scope of this technology. This Summary is not intended to be used as an aid in determining the scope of the claimed subject matter. Its purpose is to present some simplified concepts related to the technology before the more detailed description presented below.

Accordingly, aspects of the invention provide for managing information in a procedure-based medical practice to facilitate the integration of patient information storage, research, and billing functions. By presenting patient-specific user interfaces for collecting pre-procedure data, aspects of the invention provide a user with an efficient and logical way to plan and record data relating to future procedures. Moreover, by providing patient-specific user interfaces for collecting post-procedure execution, equipment, and billing data, aspects of the invention provide a user with a way to collect and analyze data relating to procedures performed. Other aspects of the invention provide for searching and summarizing the collected data for furthering research.

### BRIEF DESCRIPTION OF THE DRAWINGS

FIG. 1 is a diagram of a system of one embodiment of the invention;

FIG. 2 is a global diagram of a user interface of one embodiment of the invention;

FIG. 3 is an exemplary patient data collection and retrieval sub-interface of embodiments of the invention;

FIG. 4 is an exemplary procedure-planning sub-interface of embodiments of the invention;

FIG. 5 is an exemplary previous medical history sub-interface of embodiments of the invention;

FIG. 6 is an exemplary post-procedure execution sub-interface of embodiments of the invention;

FIGS. 7-15 depict exemplary user interfaces of a post-procedure execution and equipment billing sub-interface of embodiments of the invention;

FIG. 16 is an exemplary search sub-interface of embodiments of the invention;

FIG. 17 is an exemplary post-procedure listing of outcomes and complications of embodiments of the invention;

FIG. 18 is an exemplary tabular listing of patient procedures of embodiments of the invention;

FIG. 19 is an exemplary consent sub-interface of embodiments of the invention;

FIG. 20 is an exemplary clinical sub-interface of embodiments of the invention;

FIG. 21 is an exemplary atlas of embodiments of the invention; and

FIG. 22 is a flow diagram of a method of one embodiment of the invention.

Corresponding reference characters indicate corresponding parts throughout the drawings.

### DETAILED DESCRIPTION

### System for Managing Information in a Procedure-Based Medical Practice

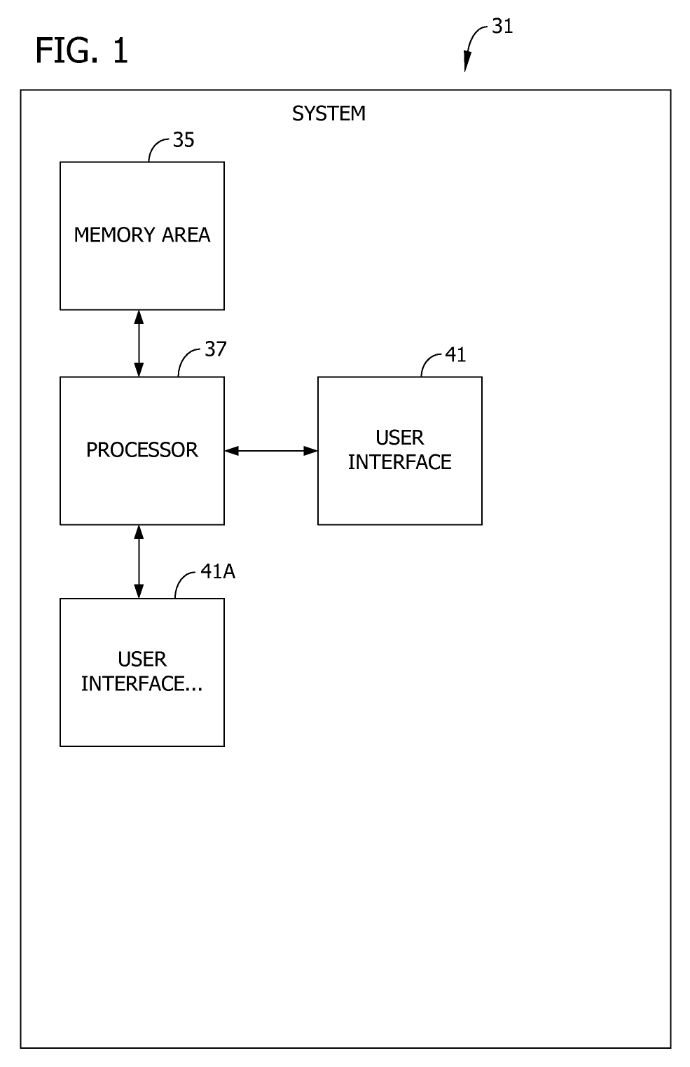

A system for managing information in a procedure-based medical practice is generally indicated 31 in FIG. 1. Such a system 31 may be executed on virtually any type of computing device. As would be readily understood by one skilled in the art, the system 31 may be executed on a personal computer, or as a served application, such as by a server to clients, on a network. Moreover, system components (discussed below) may be located on the same or different computers. For example, one or more devices can display the user interface, while one or more of the same or other devices can include the processing and memory areas.

The system 31 comprises a memory area 35 for maintaining patient data relating to a plurality of patients. The patient data represents patient identification and patient health information for each of the plurality of patients. The memory area 35 can include a number of sub-areas for particular data types. In addition, the memory area 35 may be split among one or more memory devices and/or one or more computing devices. The system 31 further comprises a processor 37 adapted for accessing, maintaining, and modifying the data stored in the memory area 35. As would be readily understood by one skilled in the art, any conventional processor associated with a computing device may be utilized without departing from the scope of embodiments of the invention.

The system 31 further comprises a patient-specific user interface 41 adapted for communicating with the memory area 35 for collecting data from and providing data to a user. The user interface 41 communicates with the memory area 35 via the processor 37. Moreover, the processor 37 displays the patient-specific user interface 41 for one or more users. The user interface 41 can be displayed in a variety of forms on a variety of different computing devices. For example, the user interface 41 can be displayed on a monitor of a personal computer, a terminal, a portable computing device, or an ultra-mobile personal computer, among others. Moreover, the system 31 can be utilized simultaneously by more than one user on more than one interface, as shown in FIG. 1 with the additional user interface 41A. Both user interfaces 41, 41A depicted in FIG. 1 utilize the same processor 37, but the present system 31 also contemplates different user interfaces accessing the memory area 35 via different processors. In addition, the system 31 can be executed on any number of operating systems, including Microsoft Windows, Apple OS, and Linux, among others.

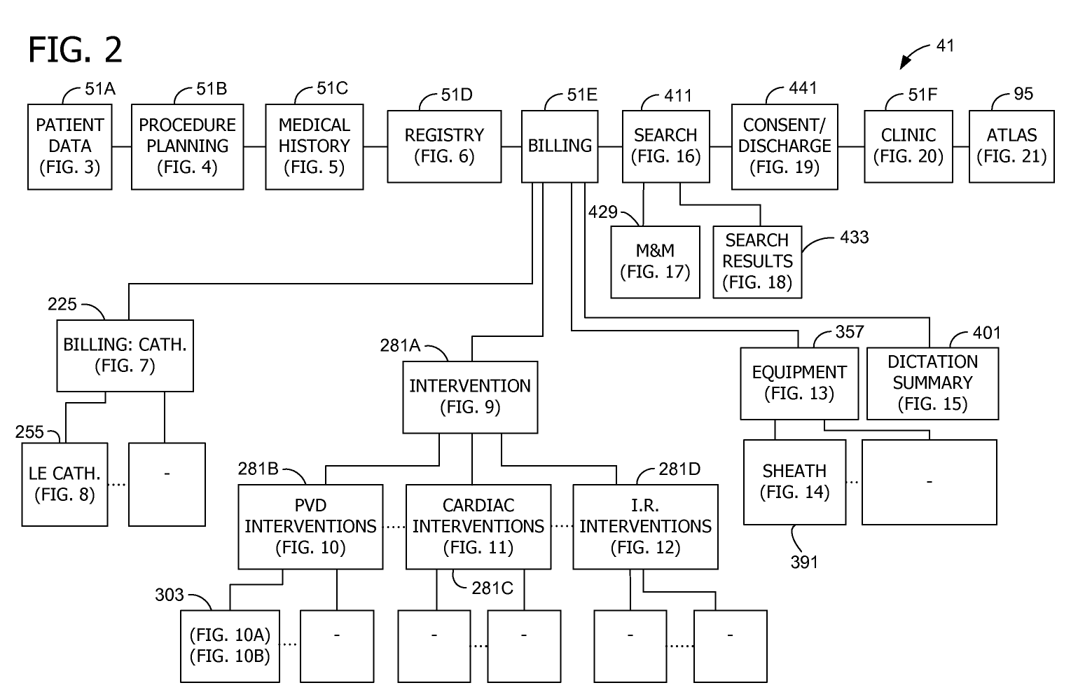

The patient-specific user interface 41 comprises several user-selectable sub-interfaces. Referring now to FIG. 2, a global diagram of a user interface 41 of one embodiment of the invention is shown. Each box of the diagram represents a particular portion (e.g., a sub-interface, a page, or a specific user interface) of the overall user interface 41. The lines linking the boxes indicate major navigation paths between the different portions of the user interface 41, although other navigation paths not shown here between different boxes are also contemplated as within the scope of embodiments of the invention. The global diagram will be referred to throughout as a navigation aid between the different user interfaces discussed below.

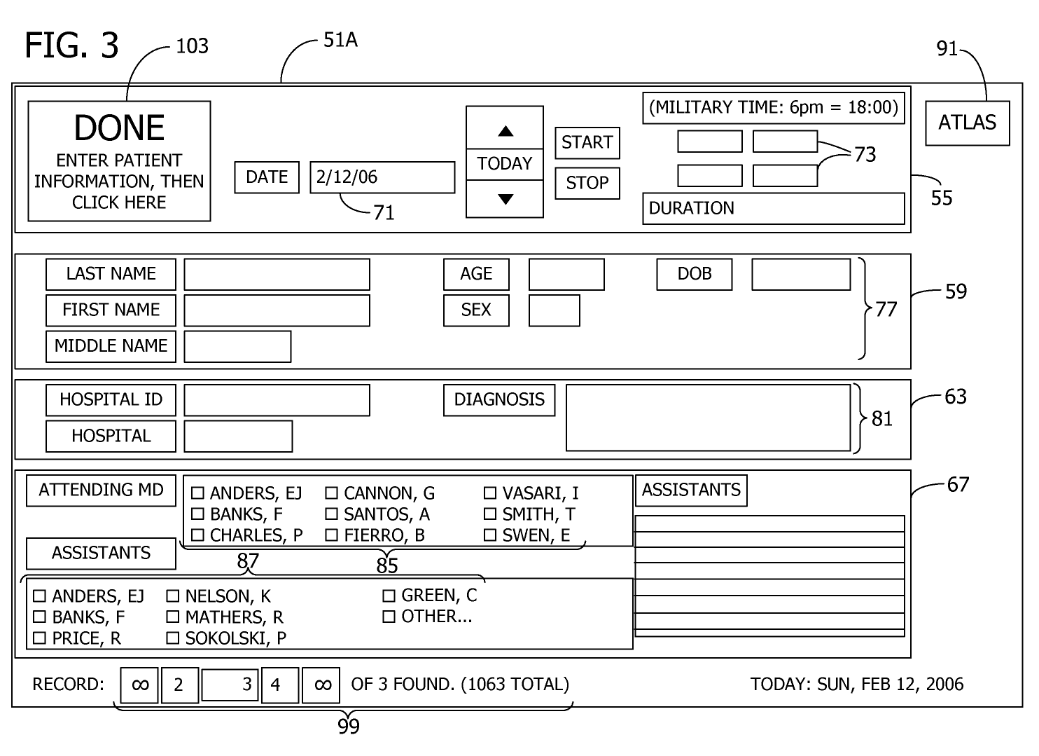

In the examples depicted in FIGS. 3-21 and discussed below, the sub-interfaces are each different windows accessible by selecting a particular selection element (e.g., a “next” selection or a tabbed selection indicating another sub-interface) on a presently accessed window. The user may navigate through the collection of sub-interfaces 51 by selecting particular selection elements on one or more other sub-interfaces indicating the transition to another user interface. The depicted user interface 41 is exemplary only, and could readily me modified to another organizational scheme (e.g., a directory tree), without departing from the scope of embodiments of the invention.

In one example, the patient-specific user interface 41 comprises a patient data collection and retrieval sub-interface 51A for collecting patient data, sending the collected data to the memory area 35 for storage, and retrieving patient data from the memory area. An exemplary patient data collection and retrieval sub-interface 51A is depicted in FIG. 3. The patient data collection and retrieval sub-interface 51A includes four sections, a date and time section 55, a patient identification section 59, a procedure identification section 63, and a staff identification section 67. One or more of these sections can be modified or deleted without departing from the scope of embodiments of the invention. Moreover, additional sections can be added to the patient data collection and retrieval sub-interface 51A without departing from the scope of the invention. More generally, throughout the following discussion of the sub-interfaces of the patient-specific user interface 41, portions of one or more of the sub-interfaces can be added, deleted, or modified without departing from the scope of embodiments of the invention.

In the example shown, the date and time section 55 provides a date dialog box 71 for entering a date corresponding to the procedure or procedures being submitted or modified via the user interface 41. The date and time section 55 further provides start and stop dialog boxes 73 corresponding to the start time and the stop time of the procedure or procedures being submitted or modified via the user interface 41. The patient identification section 59 includes several patient information dialog boxes 77, including patient name, patient age, patient gender, and patient date of birth. Again, other patient information dialog boxes 77 may be included to collect additional information about the patient. Moreover, once a user enters a first letter or letters of a particular data object into one or more of the dialog boxes, the system 31 may prompt the user with a list of potential current data objects stored in the memory area 35 that match the first letter or letters entered. The user may select one of these current data objects from the list, thereby indicating that the user is intending to enter or modify data relating to an existing patient already having information stored in the memory area 35. In such a case, the system 31 pre-fills the other patient identification dialog boxes 77 of the patient identification section 59 with the appropriate data relating to the patient. Where a user does not select a current data object, the user will instead provide the data for the dialog boxes 77 manually, which will create a new patient data object in the memory area 35.

The procedure identification section 63 of the patient data collection and retrieval sub-interface 51A comprises procedure dialog boxes 81 for data entry, including a hospital identification code, a hospital name, and a diagnosis. One or more of these procedure dialog boxes 81 may also include a pull-down menu, or other data entry devices (e.g., checkboxes), for prompting the user with a list of common data (e.g., a listing of commonly-used hospitals).

The patient data collection and retrieval sub-interface 51A also comprises selection elements representing predetermined categories of patient data for receiving selections from a user via the patient data collection and retrieval sub-interface. For example, the staff identification section 67 includes attending selection element checkboxes 85 for identifying one or more attending physicians and assistant selection element checkboxes 87 for identifying one or more assistant physicians that will participate in the procedure on the patient. Other selection elements for other types of data may also be included in the patient data collection and retrieval sub-interface 51A without departing from the scope of embodiments of the invention.

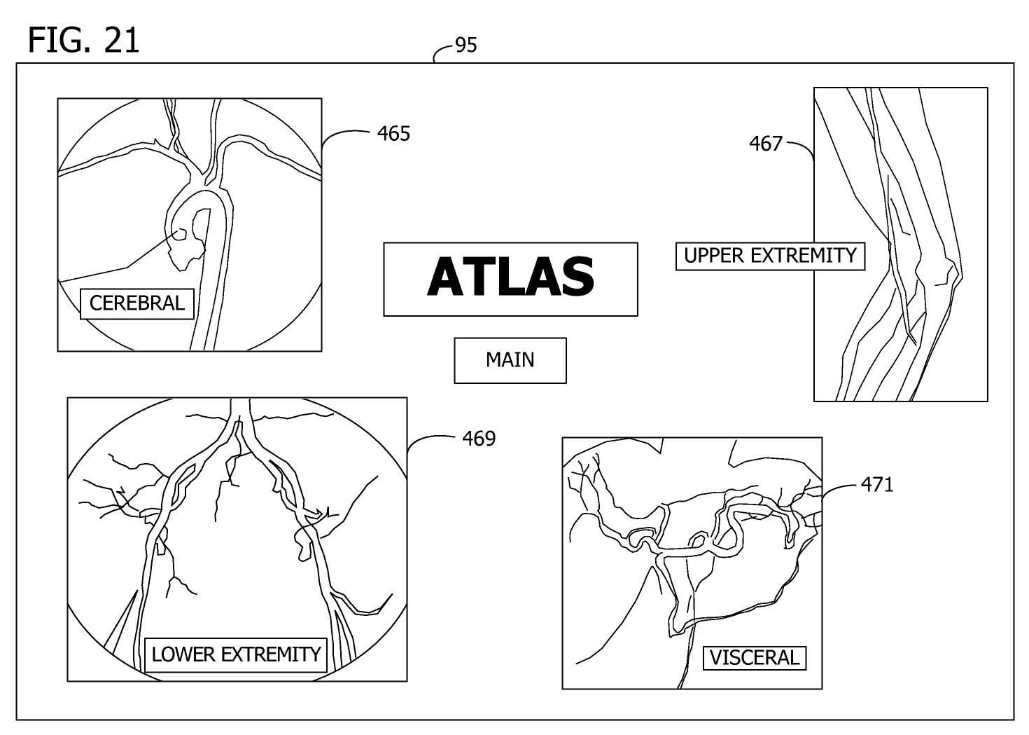

The patient data collection and retrieval sub-interface also comprises an atlas selection element 91 for an atlas of medical information relating to the procedure-based medical practice. This atlas selection element 91 is included with several of the sub-interfaces, whereby a user of the system 31 of the present invention may readily access the atlas at several points during the data entry process. This provides the user with ready access to an atlas of medical information pertaining to the procedure-based medical practice, while entering data. Selection of the atlas selection element 91 launches an atlas user interface 95, such as the interface depicted in FIG. 21 and discussed below.

The patient data collection and retrieval sub-interface 51A also comprises a record listing 99 indicating the number that the present record represents, along with the total number or records currently stored in the memory area 35. Similar record listings appear in several of the other sub-interfaces. The patient data collection and retrieval sub-interface 51A also includes an entry complete selection element 103 for the user to indicate that he has entered all patient information and is ready to move on to the next sub-interface. In the example, shown, this entry complete selection element 103 is marked “Done.”

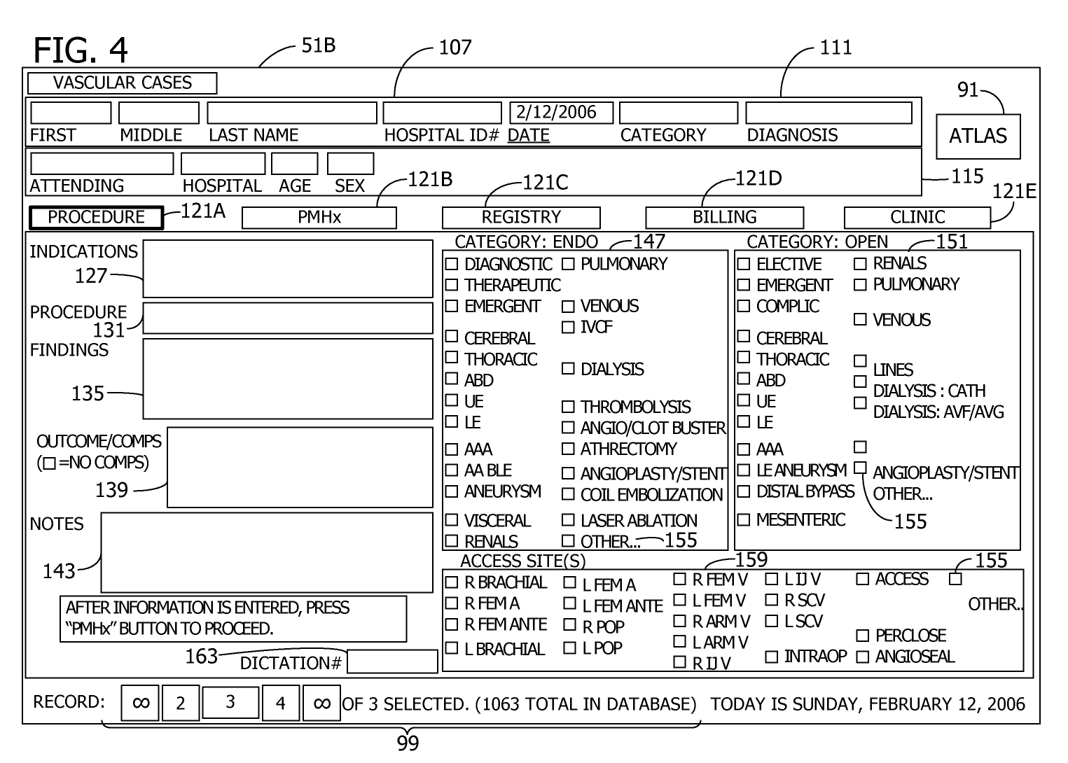

Upon selection of this entry complete selection element 103, the system 31 provides a procedure-planning sub-interface, generally indicated 51B, and depicted in FIG. 4, to the user. The procedure-planning sub-interface 51B is adapted for collecting procedure-planning data and sending the collected data to the memory area 35 for storage. The procedure-planning data relates to one or more planned medical procedures for a selected one of the patients. In the example shown, the procedure-planning sub-interface 51B comprises a patient identification section 107, a procedure identification section 111, and a staff identification section 115. Each of these sections 107, 111, 115 displays a portion of the data stored in the memory area 35, as was collected by the patient data collection and retrieval sub-interface 51A. These sections 107, 111, 115 serve as a reminder to the user regarding which patient the procedure-planning sub-interface 51B is addressing. The procedure-planning sub-interface also comprises the atlas selection element 91 and record listing 99 generally as set forth above.

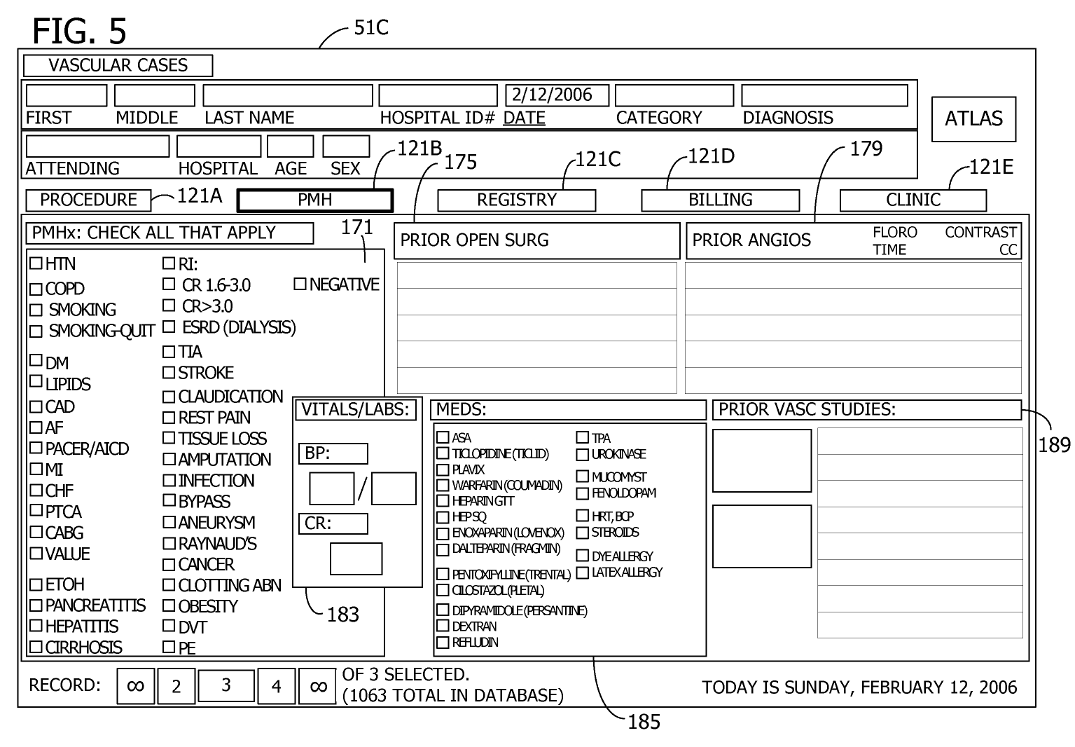

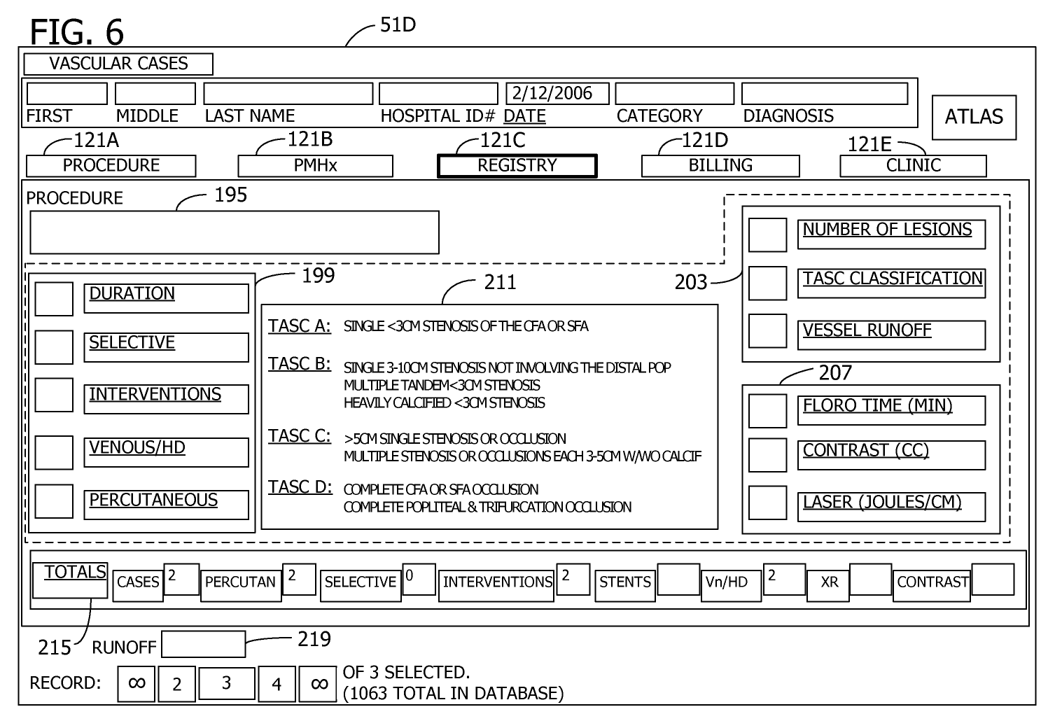

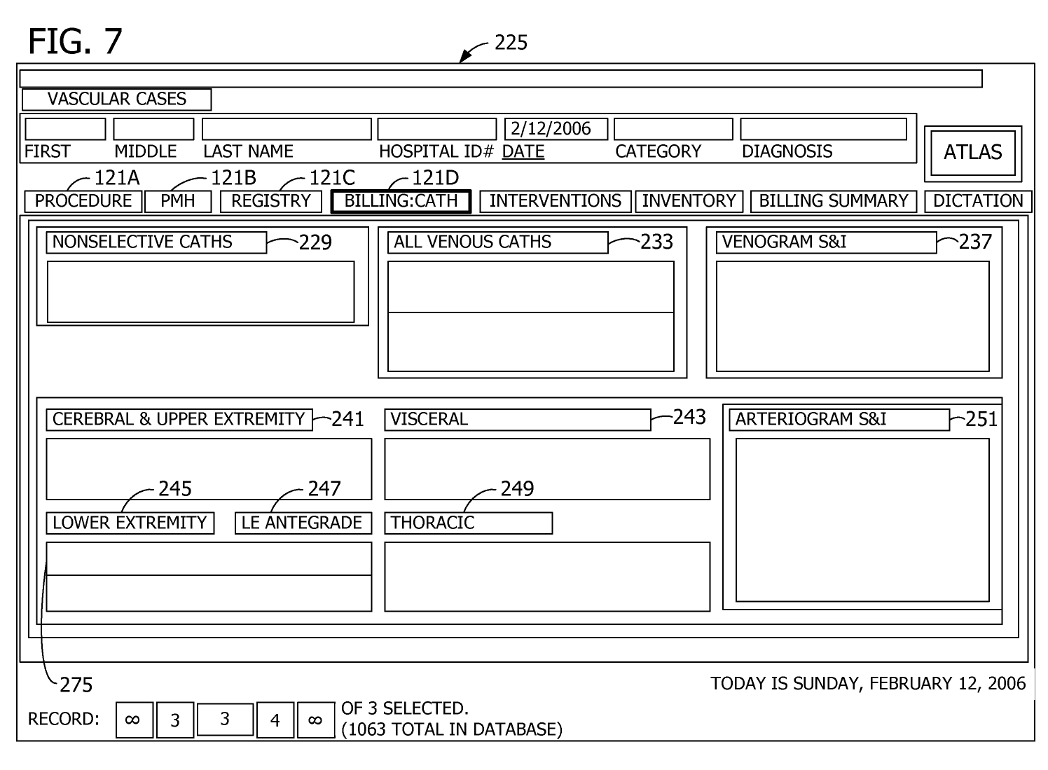

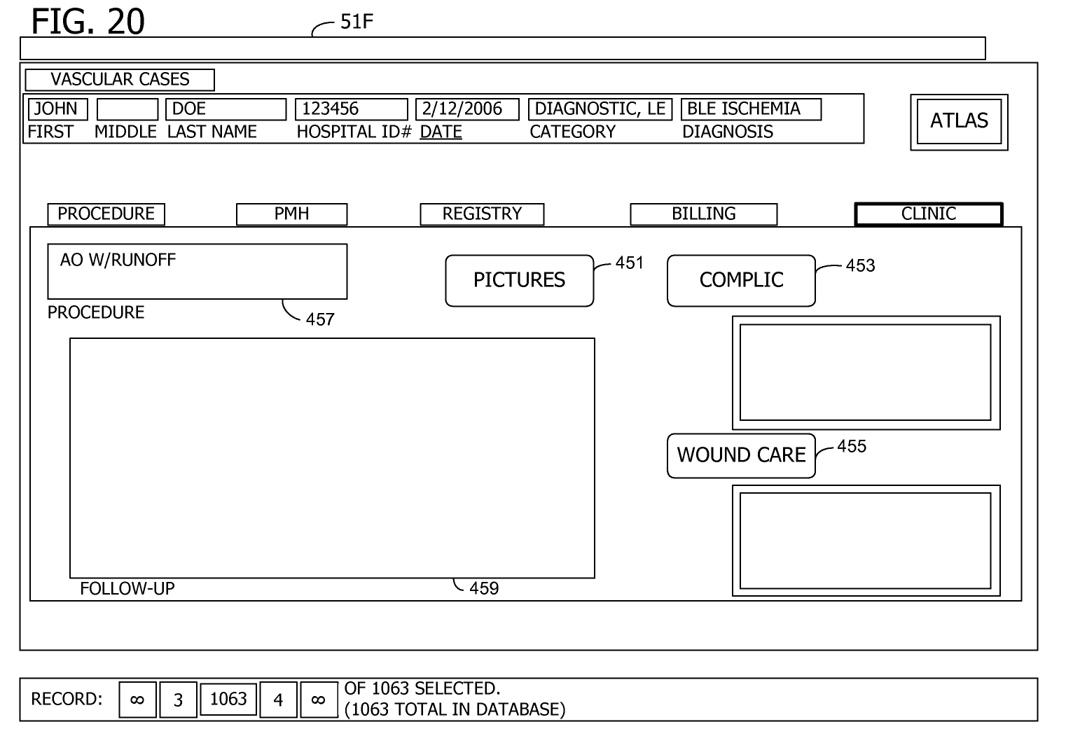

The exemplary procedure-planning sub-interface 51B depicted in FIG. 4 is configured for ready movement to and from other sub-interfaces 51. In particular, multiple selection element tabs 121 are included for toggling between each of the sub-interfaces 51. A procedure selection element tab 121A is shown selected in FIG. 4 (e.g., bolded border), indicating to the user that he is currently accessing the procedure-planning sub-interface 51B. A previous medical history selection element tab 121B allows the user to open a previous medical history sub-interface 51C (FIG. 5) for reviewing and entering data relating to the patient's previous medical history. A registry selection element tab 121C allows the user to open a post-procedure execution sub-interface 51D (FIG. 6) for collecting post-procedure execution data. A billing selection element tab 121D accesses a post-procedure execution and equipment billing sub-interface 51E (FIGS. 7-15), and a clinic selection element tab 121E accesses a clinical sub-interface 51F (FIG. 20) for use with post-procedure patient care. Each of these sub-interfaces 51 will be discussed in greater detail below.

Returning to the procedure-planning sub-interface 51B of FIG. 4, the exemplary sub-interface shown comprises several sections for user input, including an indications section 127, a procedure section 131, a finding section 135, an outcomes and complications section 139, and a notes section 143. Each of these sections 127, 131, 135, 139, 143 comprises a text box for manual entry of information by the user on each of the topics associated with each text box. For example, in the indications section 127, a user may enter text relating to some or all of the medical indications related to the planned procedure.

The procedure-planning sub-interface 51B further comprises selection elements representing predetermined categories of procedure-planning data for receiving selections from a user via the procedure-planning sub-interface. For example, the procedure-planning sub-interface 51B depicted in FIG. 4 is applicable to procedure-based practice performing open vascular and endovascular procedures. As such, the procedure-planning sub-interface 51B includes an endovascular section 147 for categorizing any planned endovascular procedures and an open vascular section 151 for categorizing any planned open vascular procedures. Both sections 147, 151 comprise a plurality of selection elements associated with the respective section.

For example, the endovascular section 147 includes broad selection elements associated with the general categories of diagnostic procedures, therapeutic procedures, and emergent procedures. Similarly, the endovascular section 147 includes procedural location categories, such as cerebral procedures, thoracic procedures, abdominal procedures, upper extremity procedures, and lower extremity procedures. Moreover, the endovascular section 147 has further selection elements related to specific conditions, including Abdominal Aortic Aneurysms (AAA), Aortic Aneurysms Both Lower Extremities (AA BLE), and Aneurysms generally. Moreover, the endovascular section 147 also includes more specific procedures, such as Thrombolysis, Angiojet thrombectomy (i.e., clot buster), and atherectomy. As would be understood by one skilled in the art, other selection elements are included in the exemplary embodiment of FIG. 4, but need not be discussed in greater detail here. Any number of selection elements may be added corresponding to any number of different general categories, medical conditions, and procedures, among others. In other words, any data may be added as a selection element, in particular those data that are often utilized in a particular procedure-based medical practice. In addition, the endovascular section 147 includes an undefined selection element 155, here labeled “other,” that may be selected when none of the other selection elements captures the appropriate data. In one example, selection of the undefined selection element 155 calls up an additional dialog box where the user can specify the additional data for capture.

Similarly, the open vascular section 151 includes broad selection elements associated with the general categories of elective procedures, emergent procedures, and complicated procedures. Moreover, the open vascular section 151 includes procedural location categories, such as cerebral procedures, thoracic procedures, abdominal procedures, upper extremity procedures, and lower extremity procedures. The open vascular section 151 also includes selection elements related to specific conditions, including Abdominal Aortic Aneurysms (AAA) and lower extremity aneurysms. Moreover, the open vascular section 151 also includes more specific procedures, such as distal bypass, angioplasty, and amputation. The open vascular section 151 further comprises an undefined selection element 155, here labeled “other,” that the user may select when none of the other selection elements captures the appropriate data.

The procedure-planning sub-interface 51B further comprises an access site section 159 comprising selection elements representing the location on a patient where a physician may obtain access for the procedure. For example, the access site section 159 includes selection elements associated with the right brachial artery, the right femoral artery, the right femoral anterior artery, and the left brachial artery, among others. The access site section 159 further comprises an undefined selection element 155, here labeled “other,” that the user can select when none of the other selection elements captures the appropriate data.

The procedure-planning sub-interface 51B also comprises a dictation number dialog box 163, whereby the system 31 or the user assigns a dictation number corresponding to the present procedure for use as part of the dictation scheme.

Although the procedure-planning sub-interface 51B depicted in FIG. 4 relates to an endovascular and open vascular practice, it would be readily understood by one skilled in the art that the same principles could be readily applied to any number of procedural-based medical practices (e.g., orthopaedics) without departing from the scope of embodiments of the invention. More broadly, the organizational structure of the entire system 31 is also readily adaptable to any number of procedural-based medical practices.

Referring now to FIG. 5, the patient-specific user interface 41 also comprises the previous medical history sub-interface 51C (associated with the previous medical history selection element tab 121B) for collecting and displaying previous medical history data of a patient. The previous medical history sub-interface 51C includes a basic medical history section 171, prior open surgeries section 175, a prior angioplasty procedures section 179, a vital signs and laboratory results section 183, a medication section 185, and a prior vascular studies section 189. Each of these sections may contain dialog boxes, selection elements, or any number of other input devices, for collecting information relating to the patient. For example, the basic medical history section 171 includes selection elements for common conditions, such as hypertension, chronic obstructive pulmonary disease, smoking status, diabetes, and high cholesterol or other lipid disorders, among others. Similarly, the medication section 185 includes selection elements for common medications, such as aspirin, ticlopidine, Plavix, coumadin, and heparin, among others. Any number of other conditions or medications may be added, respectively, without departing from the scope of embodiments of the invention. It should also be noted here that the listing of conditions and medications could be readily tailored to a particular type of patient, such as those patients in the present example requiring vascular care. For a new patient, a user may manually enter this information using the selection elements provided in the previous medical history sub-interface 51C, whereas the system 31 may also access data for an existing patient from the memory area 35 and display the data within the sub-interface 51C. Each of the prior open surgeries section 175, the prior angioplasty procedures section 179, and the prior vascular studies section 189 includes information stored in the memory area 35 and displayed in the sub-interface 51C for reference by the user.

Referring now to FIG. 6, the patient-specific user interface also comprises the post-procedure execution sub-interface 51D associated with the registry selection element tab 121C for collecting post-procedure execution data and sending the collected data to the memory area 35 for storage. The post-procedure execution data relates to one or more of the planned medical procedures, after being performed in the procedure-based medical practice. The post-procedure execution sub-interface 51D collects information relating to procedural subparts of the overall medical procedure. This collected information may be utilized in a number of ways. For an individual patient, a practitioner can review several procedural aspects in a relatively short amount of time utilizing this post-procedure execution sub-interface 51D. Moreover, by aggregating this collected information from several patients, the practitioner can readily compile data useful for research purposes. The post-procedure execution sub-interface 51D includes several sections, including a procedural statement summary section 195, a procedural count section 199, a detailed procedural section 203, and a material exposure section 207.

In particular, the procedural statement summary section 195 includes a dialog box for recording general information about the procedure. The procedural count section 199 includes several dialog boxes allowing the user to record specific information relating to the procedures applied to a particular patient. For example, a duration dialog box is included for calculating the duration of the procedure based upon a start time and a stop time of the procedure entered on the patient data collection and retrieval sub-interface 51A. A selective dialog box tracks the number, or order (e.g., first, second, third, etc.), of blood vessels selected during the procedure, such as a third order selection, as would be readily understood by one skilled in the art. An interventions dialog box tracks the total number of interventions undertaken during the procedure. Similarly, a venous dialog box allows a practitioner to track the total number of veins accessed during the procedures, and a percutaneous dialog box allows a practitioner to track the total number of times the skin of the patient's skin is pierced during the procedure. For example, a single procedure may require a single percutaneous piercing of the groin, entry into the aorta, entry into a renal artery, and finally entry into a branch. Each of these sub-procedures can be specifically recorded in the procedural count section 199 and reported to facilitate collection of research data, and as a billing guide for determining proper billing for an entire procedure.

In addition, the detailed procedural section 203 of the post-procedure execution sub-interface 51D includes dialog boxes for tracking the number of lesions, for recording a TASC classification for the lesions, and for recording vessel runoff associated with the patient, as a general measure of disease progression. As with the previous dialog boxes, a user can complete each of these dialog boxes after one or more procedures for later review on a per-patient basis or taken together. As would be readily understood by one skilled in the art, additional procedural details may also be tracked, such as for use in collecting research data, without departing from the scope of embodiments of the invention.

Moreover, the material exposure section 207 of the post-procedure execution sub-interface 51D comprises several dialog boxes for tracking patient exposure to procedural materials. For example, a fluoroscopy time dialog box tracks patient exposure to fluoroscopy imaging procedures, and a contrast dialog box tracks the amount of contrast utilized during such a procedure. Moreover, a laser dialog box allows for tracking of the energy per distance utilized in closure of the percutaneous piercing of the patient. Each of these exposure dialog boxes relates to exposure to procedural materials and may be readily utilized in research, such as for the study of patient exposures.

The post-procedure execution sub-interface 51D also comprises a lesion classification guide 211, providing detailed information regarding assigning the appropriate TASC (TransAtlantic InterSocietal Consensus on Peripheral Arterial Occlusive Disease) code associated with each portion of the procedure. The lesion classification guide 211 is included as a reference for the practitioner entering data into the post-procedure execution sub-interface 51D.

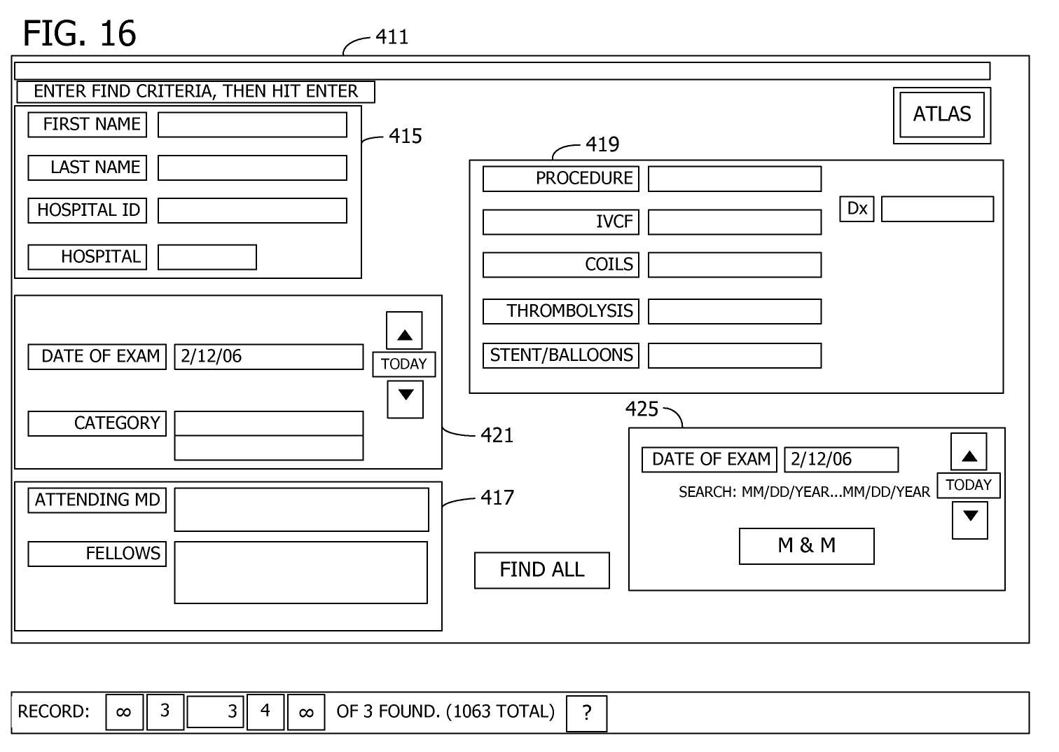

The post-procedure execution sub-interface 51D also includes a summary section 215, displaying aggregate data for all patients (e.g., all patients of a particular practitioner, all patients of a particular practice, etc.). In the example shown, the summary section 215 displays aggregate data for each of (i) the total number of cases, or procedures, performed, (ii) the total number of percutaneous piercings, (iii) the total number, or order, of vessels selected, (iv) the total number of interventions, (v) the total number of stents placed, (vi) the total number of veins accessed, (vii) the total duration, or number, of fluoroscopy procedures, and (viii) the total volume of contrast utilized. This patient summary section 215 provides a ready reference for the practitioner regarding the current tally for each of the data types. A more detailed data search and review mechanism is discussed in detail below with respect to FIGS. 16-18.

The post-procedure execution sub-interface 51D also includes a runoff dialog box 219 whereby a practitioner can input a number indicative of the open vessels in a patient (e.g., calf vein runoff), which is indicative of disease progression. As would be readily understood by one skilled in the art, any number of other dialog boxes may also be included for other relevant data, without departing from the scope of embodiments of the invention.

Referring again to FIG. 2, the patient-specific user interface 41 additionally comprises a post-procedure execution and equipment billing sub-interface, indicated 51E in FIG. 2, for collecting post-procedure execution and equipment billing data. Billing for such a procedure-based medical practice generally comprises (1) billing for placement of the catheter, (2) billing for appropriate S&I (supervision and interpretation) codes, and (3) billing for other incidentals (e.g. images, pharmaceuticals, and equipment used, among others). As such, the post-procedure execution and equipment billing sub-interface 51E comprises multiple user interfaces organized in a tree format, such as depicted in FIG. 2 and discussed in detail below.

Referring specifically to FIG. 7, a catheter use user interface of the post-procedure execution and equipment billing sub-interface 51E is generally indicated at 225. The catheter use user interface 225 provides selection elements associated with one or more of the categories of catheters utilized during the procedure. In particular, the selection elements associated with the catheters are organized by use, including a Nonselective Catheters selection element 229, an All Venous Catheters selection element 233, and a Venogram S&I codes selection element 237. Additional catheter selection elements are organized by procedural location categories, including a cerebral and upper extremity selection element 241, a visceral selection element 243, a lower extremity selection element 245, a lower extremity antegrade selection element 247, a thoracic selection element 249, and an arteriogram S&I selection element 251.

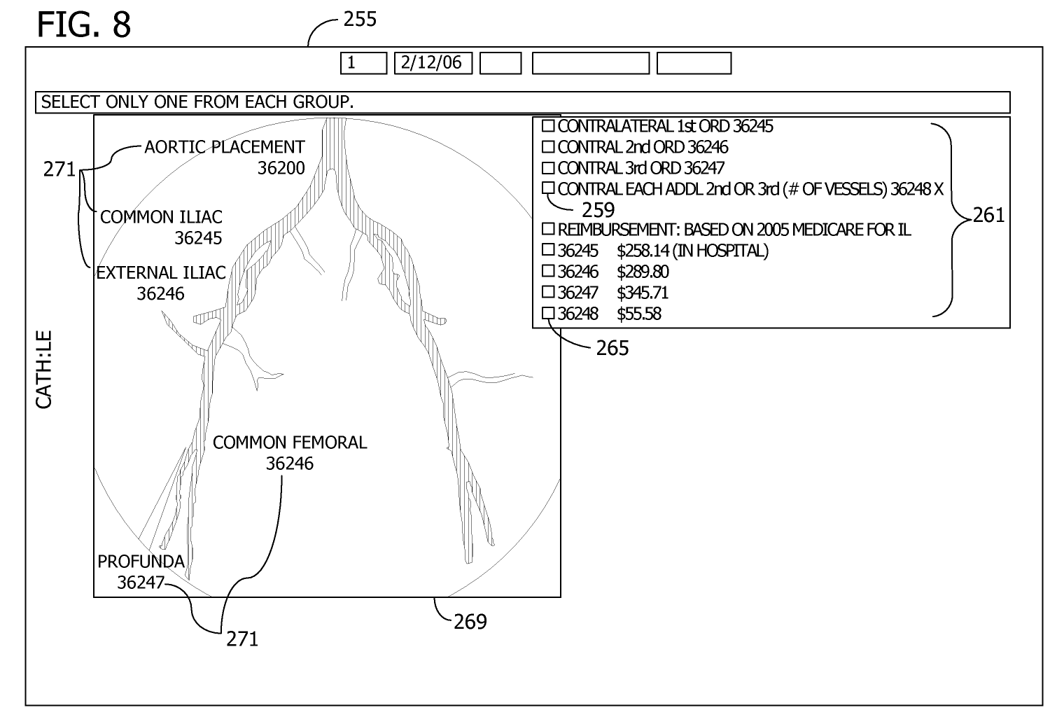

Each of these selection elements 229, 233, 237, 241, 243, 245, 247, 249, 251 links to a respective user interface for entering data related to the category of the selection element. For example, the user interface will provide a user selecting the lower extremity selection element with a lower extremity catheter user interface 255 (FIGS. 2 and 8) that allows the user to select one or more catheter placements utilized in the lower extremity procedure, or more generally, predetermined categories of procedural subparts of the overall procedure. To facilitate selection, the lower extremity catheter user interface 255 includes check boxes 259 associated with particular procedures for prompting the user with a list of common data 261 associated with lower extremity catheters. The procedure list of common data 261 includes the billing code associated with each procedure, whereby the user can see the code associated with the selected procedure. The lower extremity catheter user interface 255 also includes check boxes 265 associated with each of the billing codes and their particular estimated insurance reimbursement. In this manner, the user can also select the appropriate billing code and cost estimate associated with the selected procedure.

To further facilitate selection of the correct code by the user, which facilitates proper billing practices, the lower extremity catheter user interface 255 may further display an actual anatomical image 269, rather than a diagram or figure, incorporating selection elements 271, or labels, associated with the billing codes at anatomically representative locations in the anatomical image. For example, in the anatomical image 269 of FIG. 8, the selection element 271 for the code for aortic placement (e.g., code 36200) is displayed on the anatomical image at the actual, surgical placement location. In this manner, the user can see the anatomical location of the selected code, which facilitates more efficient selection. In one example, selection of the selection element 271 associated with a particular catheter placement will also check the checkbox 259 associated with this catheter placement and the checkbox 265 associated with the corresponding billing code. Thus, in this example, the user can exclusively use the selection elements 271 located on the anatomical image to select catheter placements and billing codes.

In another example that further facilitates selection, the lower extremity catheter user interface 255 displays a color-coded anatomical image 269 for demonstrating to a user the locations of the selection elements at the anatomically representative locations. In the example of FIG. 8, the coded blood vessels are colored (e.g., red) to enhance the user's ability to discern code locations.

After the user has selected one or more data selection elements from the accessed user interface (e.g., the lower extremity catheter user interface 255), those selections will then be listed in the box 275 (FIG. 7) adjacent the corresponding user interface selection element (e.g., the lower extremity selection element 245). Generally, the user can review the selections made in the several user interfaces associated with the selection elements 229, 233, 237, 241, 243, 245, 247, 249, 251 (e.g., the lower extremity catheter use interface 255) in the base user interface (e.g., catheter use user interface 225) from which the particular user interface was selected. In addition, the box 275 also lists a billing code and estimated insurance reimbursement associated with each selected catheter placement for user review.

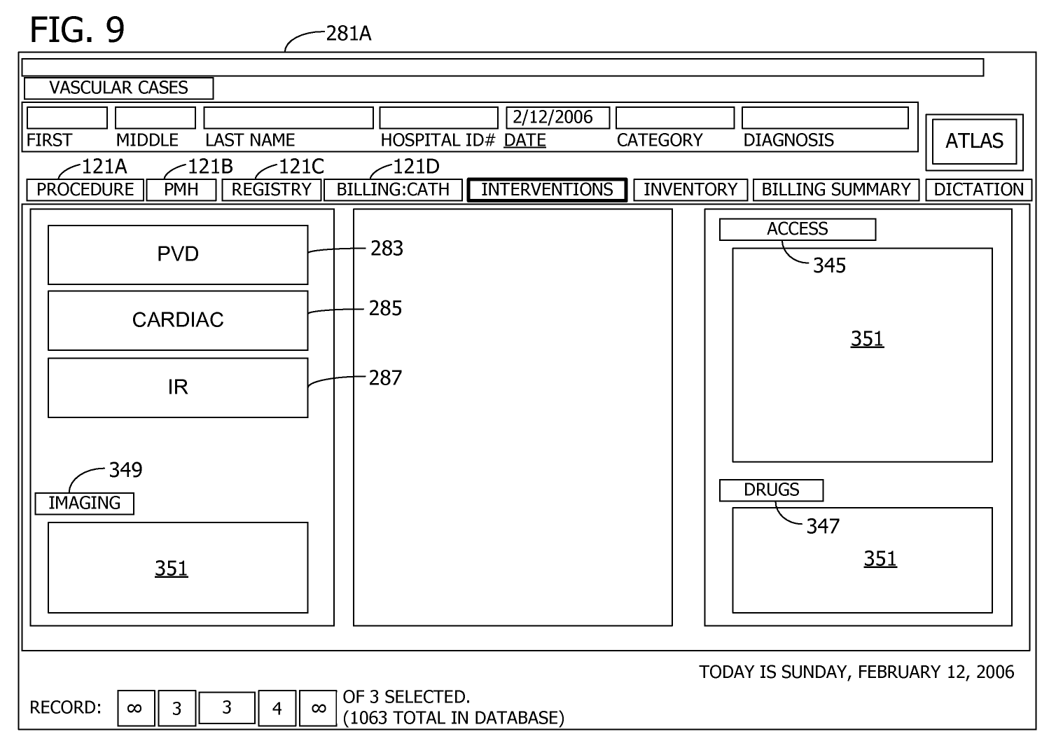

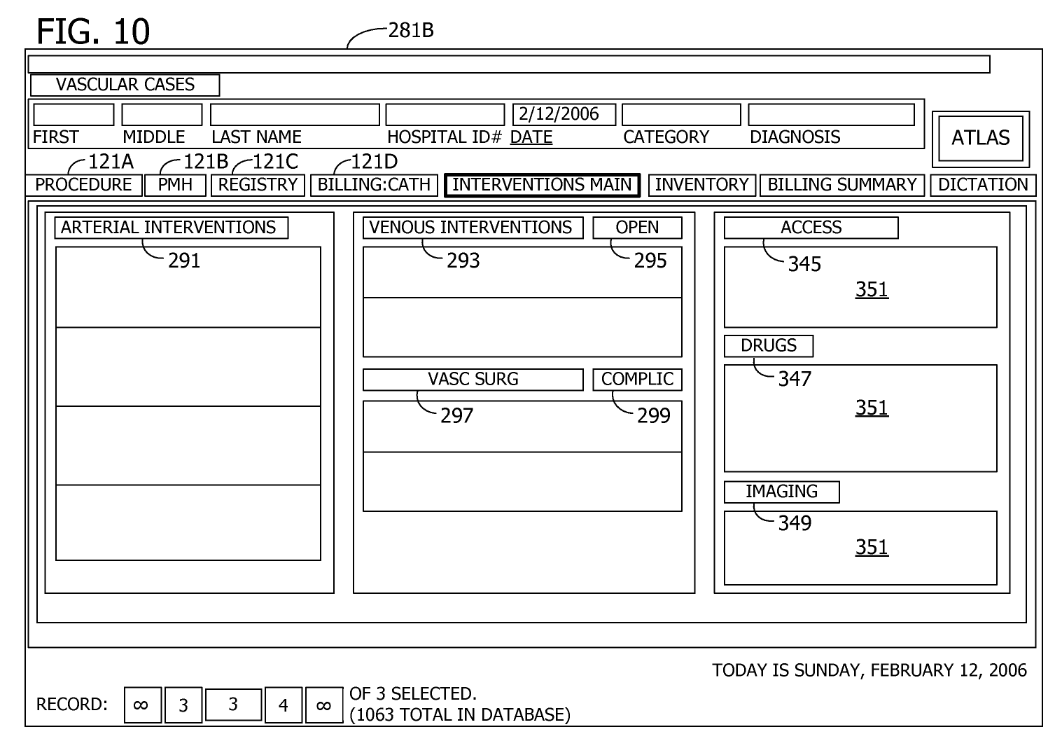

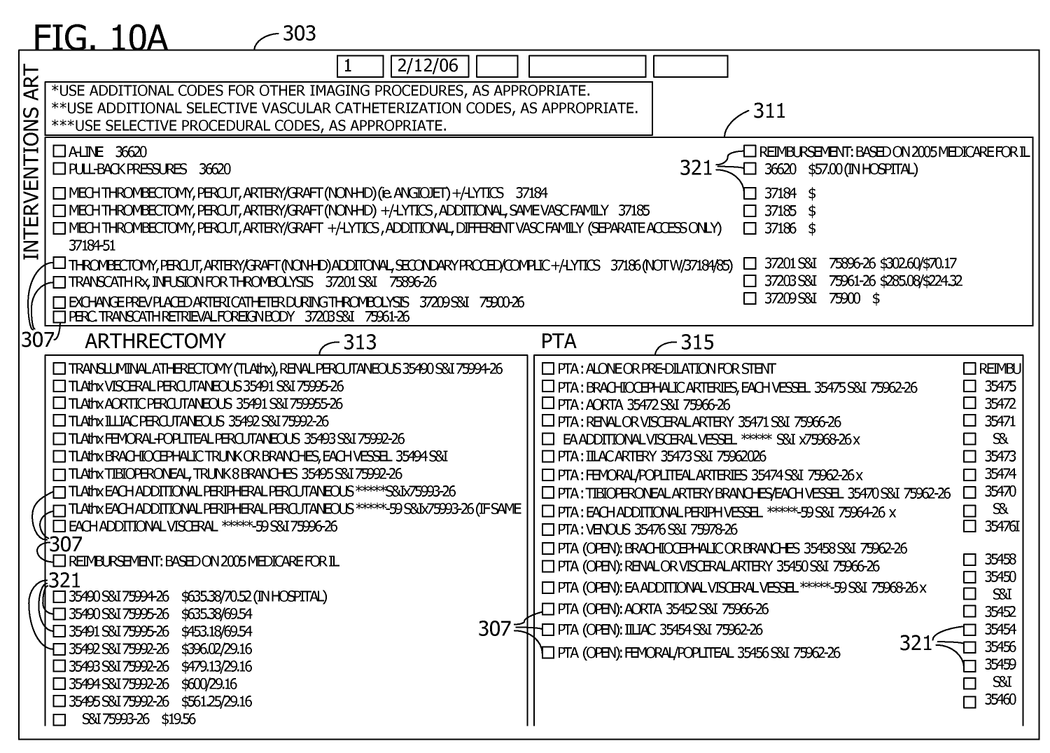

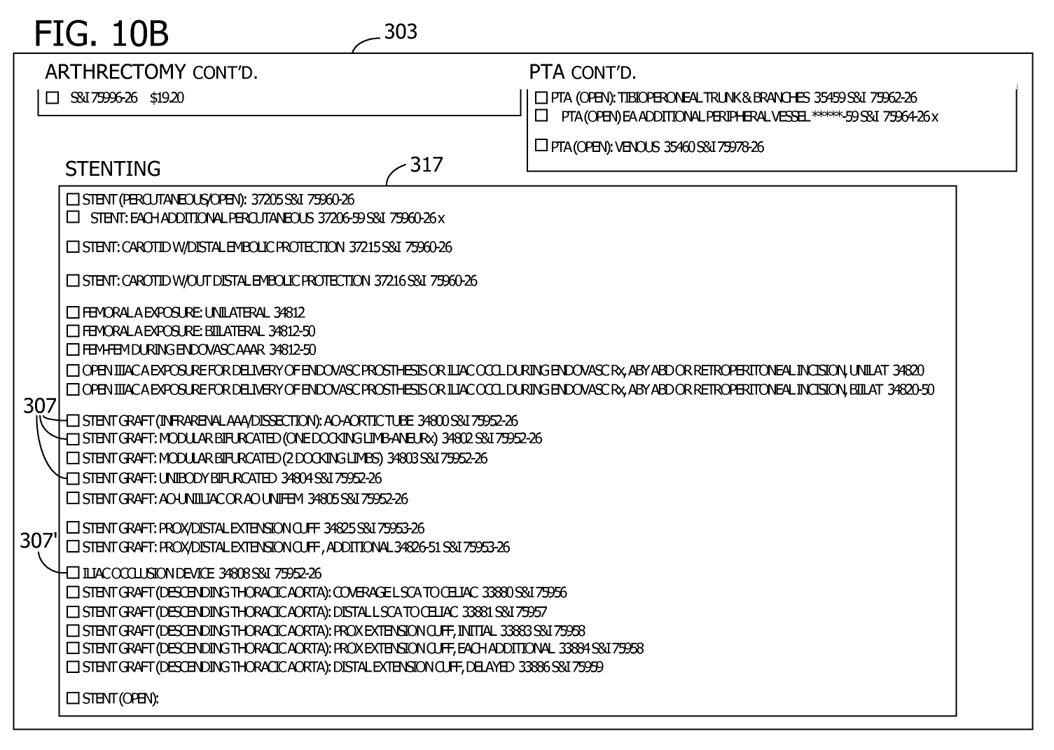

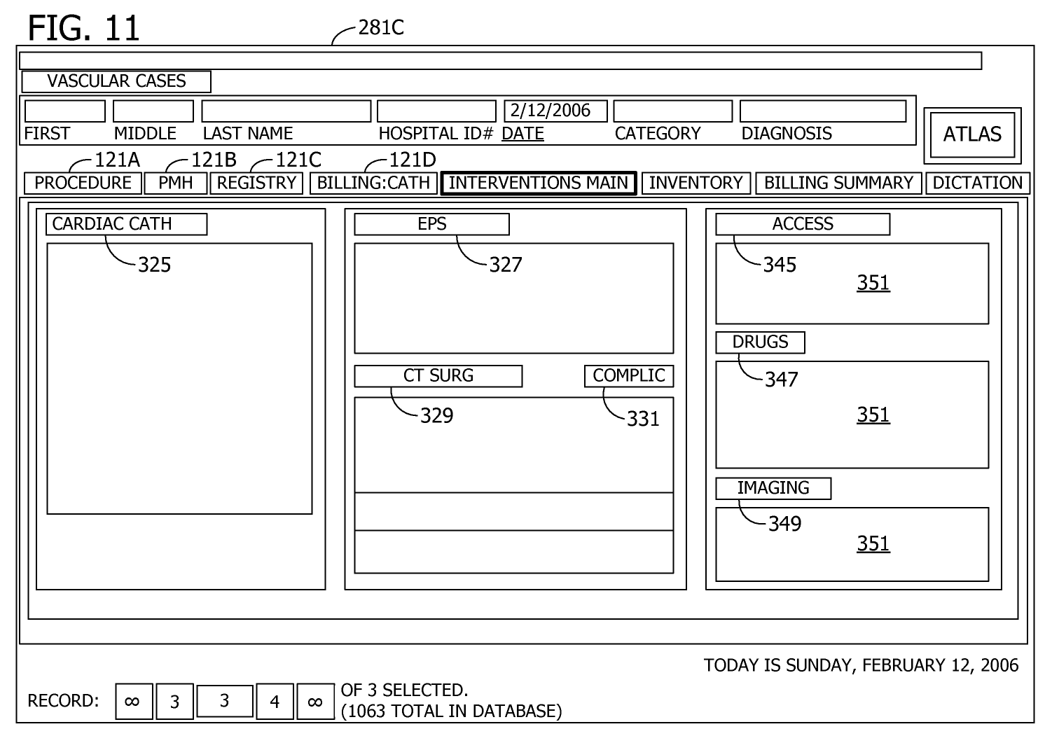

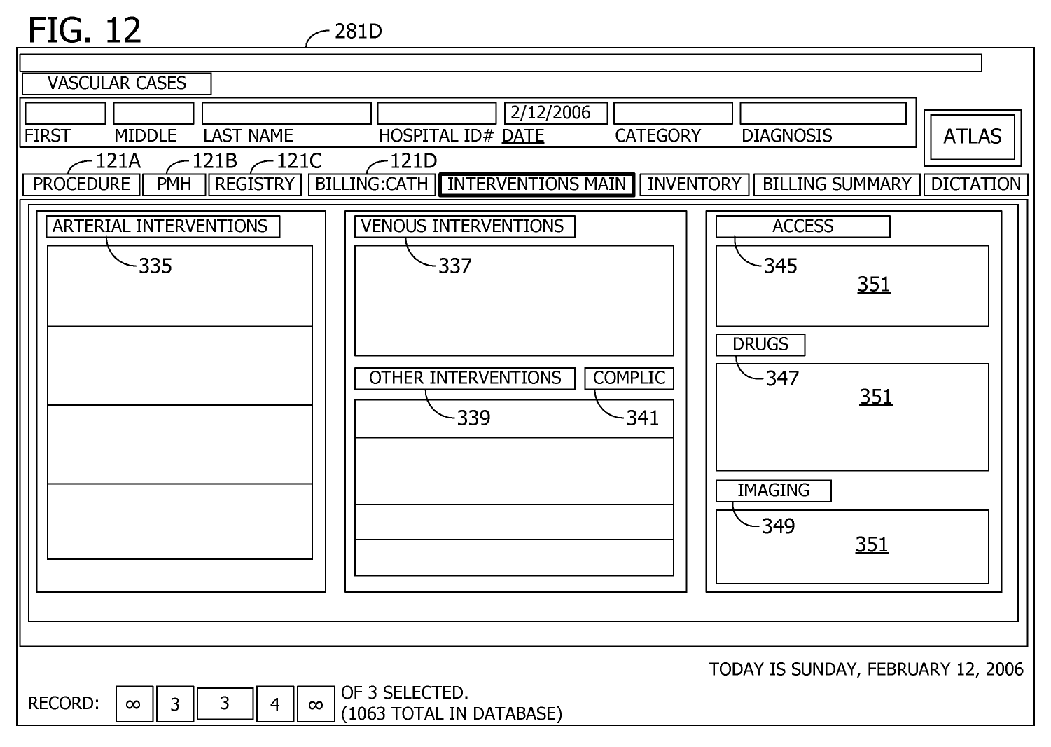

Referring now to FIGS. 9-12, four interventions user interfaces 281 are shown, including a root interventions user interface 281A (e.g., FIG. 9). The root interventions user interface 281A provides a PVD (peripheral vascular disease) selection element 283, a cardiac interventions selection element 285, and an IR (interventional radiology) interventions selection element 287, each of which launches a corresponding PVD interventions user interface 281B (e.g., FIGS. 2 and 10), a cardiac interventions user interface 281C (e.g., FIGS. 2 and 11), and an IR interventions user interface 281D (e.g., FIGS. 2 and 12). Each of these intervention user interfaces 281A-D is organized for selection of particular procedures based upon subject matter. The operation of each of these user interfaces 281A-D is discussed below.

Selecting the PVD selection element 283 in FIG. 9 takes the user to a PVD interventions user interface 281B (FIG. 10) for selection of the appropriate PVD interventions. The PVD interventions user interface 281B includes an arterial interventions selection element 291, a venous interventions selection element 293, an open venous selection element 295, a vascular surgery selection element 297 (e.g., amputations), and an outcomes and complications selection element 299 (e.g., trauma procedures). In one example, the arterial interventions selection element 291 is colored one color (e.g., red), while the venous interventions selection element 293 and the open venous selection element 295 are colored another color (e.g., blue). The color-coding is included as a visual aid to the user for assisting in readily identifying the venous versus arterial interventions to the user. Selection of the arterial interventions selection element 291 provides the user with the arterial interventions user interface 303 depicted in FIGS. 10A and 10B, which is discussed in greater detail below. The other selection elements 293, 295, 297, 299 function similarly. In particular, selection of one of the venous interventions selection element 293, the open venous selection element 295, the vascular surgery selection element 297, and the outcomes and complications selection element 299 will provide the user with one of a venous interventions user interface, an open venous user interface, a vascular surgery user interface, or an outcomes and complications user interface, respectively. These additional user interfaces are not depicted herein, but can be constructed similar to the arterial interventions user interface 303 of FIGS. 10A and 10B.

Referring now specifically to FIGS. 10A and 10B, the arterial interventions user interface 303 is depicted. This user interface 303 includes a listing of each of the procedure codes associated with arterial interventions and corresponding selection elements 307 (e.g., checkboxes) associated with the arterial interventions. By providing data links between the collected procedural subpart (e.g., an arterial intervention, such as an arterial line) and the billing code associated with the collected procedural subpart (e.g., 36620), the user may make a single selection, by recalling either the code or the intervention. The selection elements 307 of the arterial interventions user interface 303 may be grouped in any number of ways to aid in finding a desired selection element. For example, in the example of FIGS. 10A and 10B, the selection elements 307 are organized into an arterial interventions group 311, an atherectomy group 313, a PTA (Percutaneous Transluminal Angioplasty) group 315, and a stenting group 317. Other groupings, and a user interface allowing for adjustment of the groupings (e.g., sorting the selection elements 307 into groups based upon particular criteria), are also contemplated as within the scope of embodiments of the invention. In addition to selection elements 307 for the arterial interventions group 311, the arterial interventions user interface additionally includes selection elements 321 associated with estimated reimbursements for each of the selectable arterial interventions. Because the estimated reimbursements and the interventions are each included on a single user interface, the user can readily review each of the billing options for a particular procedure to ensure that each step of a procedure is properly billed. Moreover, where one or more codes may be applied to a procedure, a user may select the code that more accurately reflects the procedure. This helps reduce the likelihood that a user omits proper billing codes. The details of each intervention, code, and reimbursement shown in FIGS. 10A and 10B will not be discussed in detail here, as one skilled in the art would readily understand the meaning and use of each.

Moreover, portions of the post-procedure execution and equipment billing sub-interface 51E can include data links between groups of two or more related procedural subparts, or billing codes. User selection of one of the two or more procedural subparts via the post-procedure execution and equipment billing sub-interface automatically selects the other of the two or more procedural subparts according to the data link. For example, the arterial interventions user interface 303 of FIGS. 10A and 10B can include such data links. In particular, the stenting group 317 includes a selection element 307′ for an endovascular stent graft repair of the descending thoracic aorta, involving coverage from the left subclavian artery origin to the celiac artery origin and including radiological supervision and interpretation. Proper billing for this procedure can include two codes (i.e., 33880 and 75956), whereby selection of the selection element 307′ automatically includes both codes. As would be readily understood by one skilled in the art, linking of these two codes is beneficial to the user and can minimize billing omissions and mistakes. For example, one of the two or more procedural subparts can be an interventional procedure, while another of the two or more procedural subparts is an interpretation procedure.

Returning to FIG. 9, selecting the cardiac interventions selection element 285 takes the user to the cardiac interventions user interface 281C (FIG. 11) for selection of the appropriate cardiac interventions. The cardiac interventions user interface 281C includes a cardiac catheterization selection element 325, an EPS (an electrophysiologic study, such as for a pacemaker study) selection element 327, a cardiothoracic surgery selection element 329, and an outcomes and complications selection element 331. As with the selection elements 291, 293, 295, 297, 299 of the PVD interventions user interface 281B, selection of one of the cardiac catheterization selection element 325, the EPS selection element 327, the cardiothoracic surgery selection element 329, and the outcomes and complications selection element 331 provides the user with a corresponding user interface (not shown). Although these additional user interfaces are not depicted herein, one skilled in the art would readily understand that they could be constructed similarly to the user interface 303 of FIGS. 10A and 10B.

Returning again to FIG. 9, selecting the IR interventions selection element 287 takes the user to the IR interventions user interface 281D (FIGS. 2 and 12) for selection of the appropriate IR interventions. The IR interventions user interface 281D includes an arterial interventions (e.g., drain tube placement) selection element 335, a venous interventions selection element 337, an other interventions selection element 339, and an outcomes and complications selection element 341. As with the selection elements 291, 293, 295, 297, 299 of the PVD interventions user interface 281B, selection of one of the arterial interventions selection element 335, the venous interventions selection element 337, the other interventions selection element 339, and the outcomes and complications selection element 341 provides the user with a corresponding user interface (not shown). Although these additional user interfaces are not depicted herein, one skilled in the art would readily understand that they could be constructed similarly to the user interface 303 of FIGS. 10A and 10B.

Referring now to FIGS. 9-12, each of the user interfaces 281A-D also includes an access selection element 345, a drugs, or medications, selection element 347, and an imaging selection element 349. Each of these selection elements (accessed via any of the user interfaces 281A-D) provides user access to a corresponding one of an access user interface, a drug user interface, and an imaging user interface, none of which is shown. In one example, the access user interface provides the user with pull-down menus, or other data entry devices, for prompting the user with a common list of procedures requiring access, such as diagnostic procedures, stent placement, placement of a peripheral IV (intravenous) line, placement of a PICC (Peripherally Inserted Central Catheters) line, placement of a central IV line, hemodialysis, placement of an arteriovenous graft, and placement of an arteriovenous fistula, among others. The access user interface may also provide the user with a data entry location for data relating to who performed the procedure, such as if someone other than the attending physician performed the procedure. The drugs user interface provides the user with pull-down menus, or other data entry devices, for prompting the user with a common list of medications utilized in such procedures, such as anesthetic (including local, regional, and general anesthetic, including an associated physician code), any contrast utilized, any CO₂ gas angiogram procedures, and nitroglycerin, among others. The imaging user interface provides the user with pull-down menus, or other data entry devices, for prompting the user with a common list of additional imaging services that are often billable above the cost of performing the procedure. Such imaging services can include ultrasound studies, for example, among others. For each of these three user interfaces, the selections provided by the data entry devices can also include the billing code associated with each of the access procedures, medications, and or images selected and an estimated insurance reimbursement payment. Once the user makes one or more selections in one or more of the user interfaces, the system 31 lists such selections, along with their billing code and estimated insurance reimbursement payments, in the respective box 351 beneath each of the selection elements 345, 347, 349 on the user interfaces 281A-D. Thus, the user interfaces provide the user with a current snapshot of any additional billable features associated with access, drugs, or imaging.

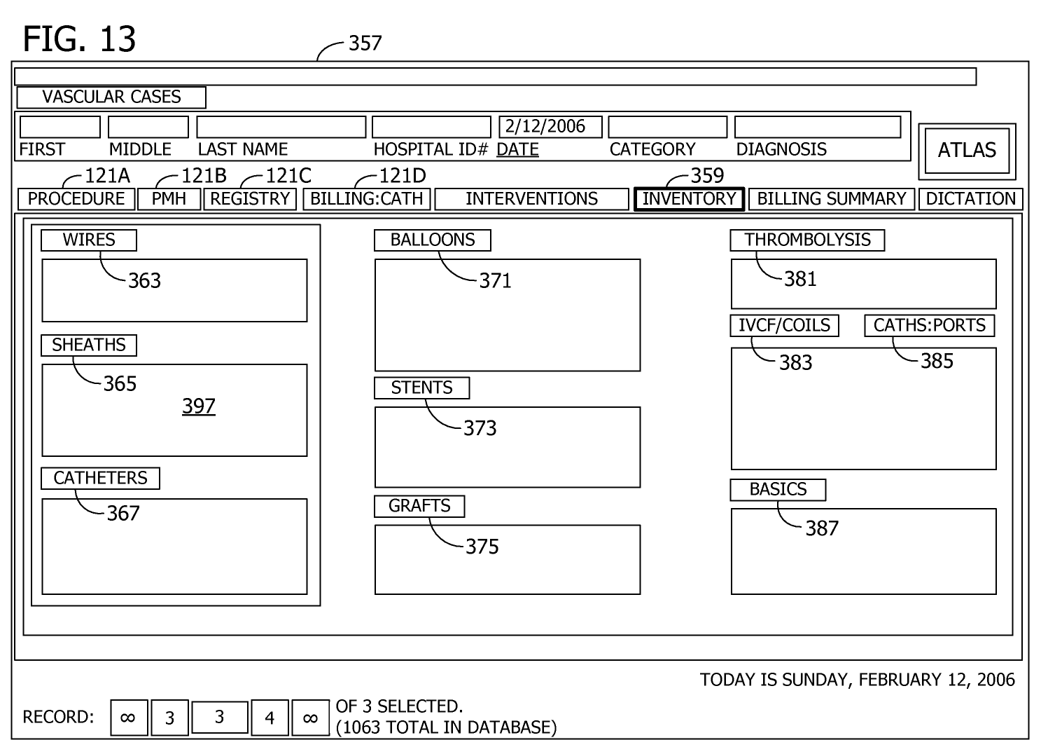

Referring now to FIG. 13, the patient-specific user interface 41 also comprises a post-procedure equipment user interface 357 accessible by selecting an “inventory” tab 359 for collecting post-procedure equipment billing data and sending the collected data to the memory area 35 for storage. A user accesses the post-procedure equipment user interface 357 by selecting the inventory tab in any of the user interfaces (225, 281A-D). The post-procedure equipment billing data relates to equipment utilized during the one or more of the planned medical procedures after being performed in the procedure-based medical practice. The post-procedure equipment user-interface 357 depicted in FIG. 13 comprises several equipment group selection elements, including a wires selection element 363, a sheath selection element 365, a catheter selection element 367, a balloon selection element 371, a stent selection element 373, a graft selection element 375, a thrombolysis equipment selection element 381, an IVCF/COILS (interior vena cava filters) selection element 383, a CATHS:PORTS (catheters and ports) selection element 385, and a BASICS selection element 387. A user may select these selection elements to launch a corresponding user interface.

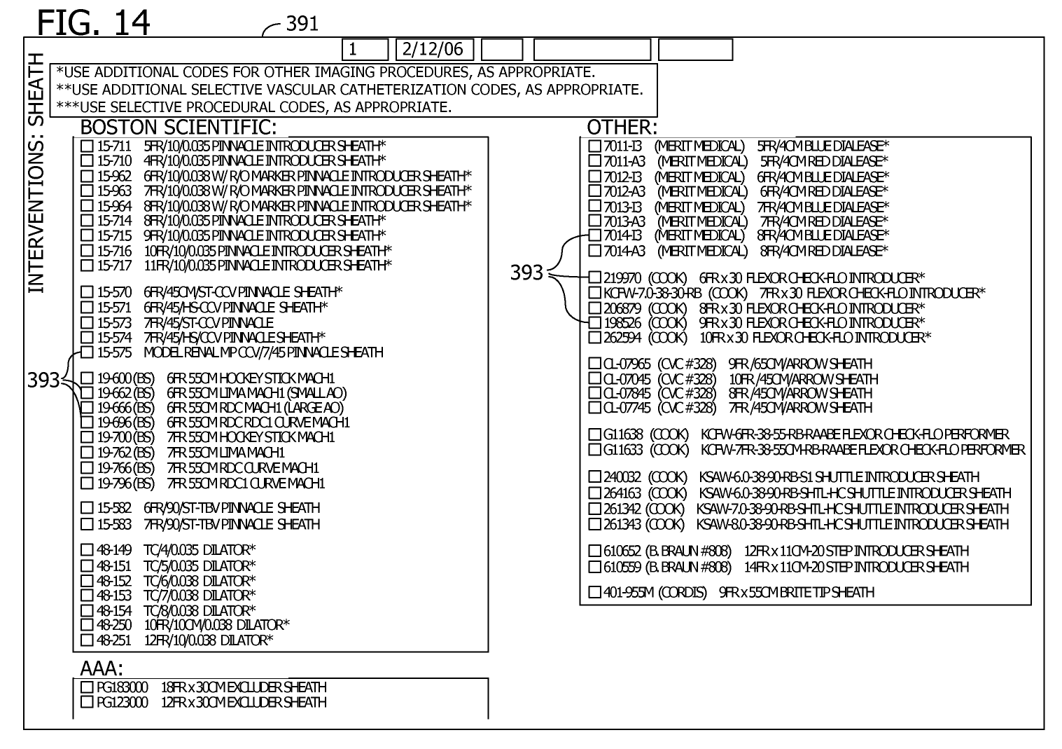

For example, selecting the sheaths selection element 365 will launch a sheaths user interface 391, depicted in FIG. 14. The sheaths user interface 391 includes selection elements 393 representing predetermined categories of equipment billing data for receiving selections from the user. In the example shown, the sheaths user interface 391 groups the sheaths by manufacturer, although other groupings may also be utilized without departing from the scope of embodiments of the invention. To utilize the sheaths user interface 391, the user simply selects one or more sheath selection elements 393 utilized during the current procedures. As with the other user interfaces discussed above, this information is stored to the memory area 35 and is displayed in the box 397 adjacent the sheath selection element 365 in FIG. 13 when the user returns to this user interface 357. After collection, such information may be used to determine what inventory should be reordered, for example.

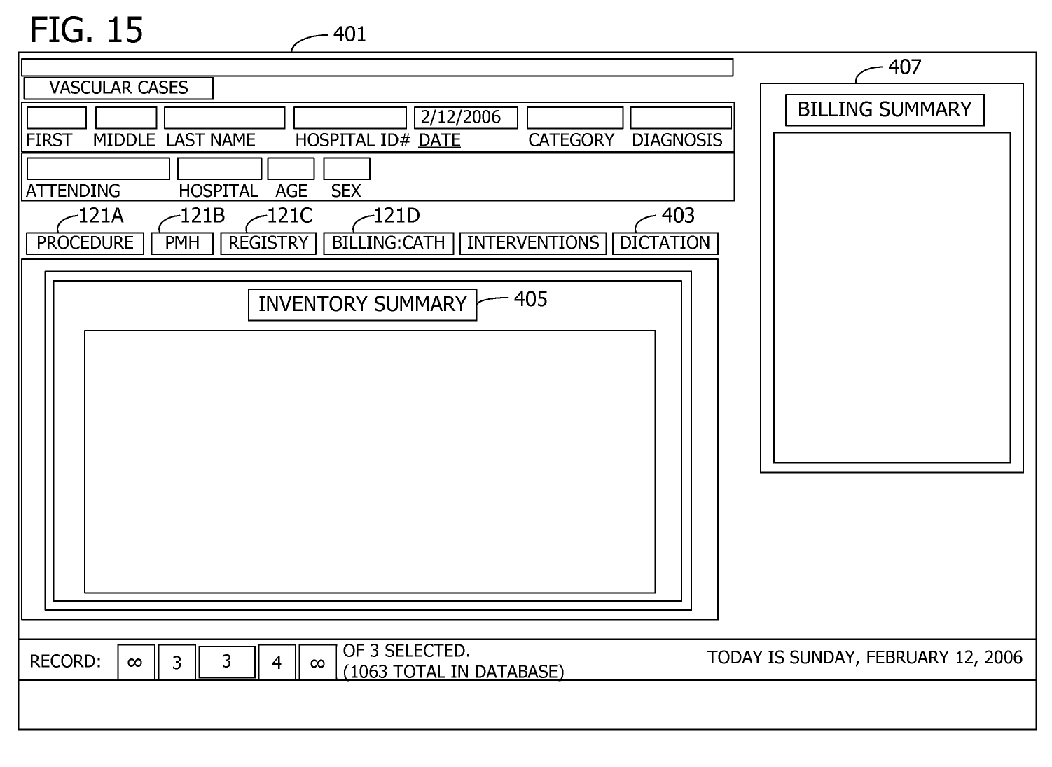

Turning to FIG. 15, once the user has completed any of the necessary equipment user interfaces, the patient-specific user interface provides a dictation summary user interface 401 accessible by selecting a “dictation” tab 403 for use by the user in dictating the procedure, such as for a patient chart and/or billing. In particular, the dictation summary user interface 401 includes an inventory summary 405 for displaying the equipment used during the procedures and a billing summary 407 for displaying the specific procedures used. By including all of this stored information on the single dictation summary user interface 401, the user can readily dictate the results of the case without referencing multiple user interfaces. Thus, the user can readily dictate the procedures applied to any patient by referencing only the dictation summary user interface 401.

Referring now to FIG. 16, the patient-specific user interface 41 further comprises a search sub-interface 411 adapted for communication with the memory area 35 for searching any of the collected data and collecting a subset of the collected data for review by a user. In the example shown, a user may search one or more of several different data fields, including patient information 415, attending physician information 417, procedure and equipment type used 419, and the date of the examination or procedure 421, among others. In addition, the search sub-interface 411 includes an outcomes and complications search interface 425 for searching previous procedures for data relating to outcomes and complications, as discussed below.

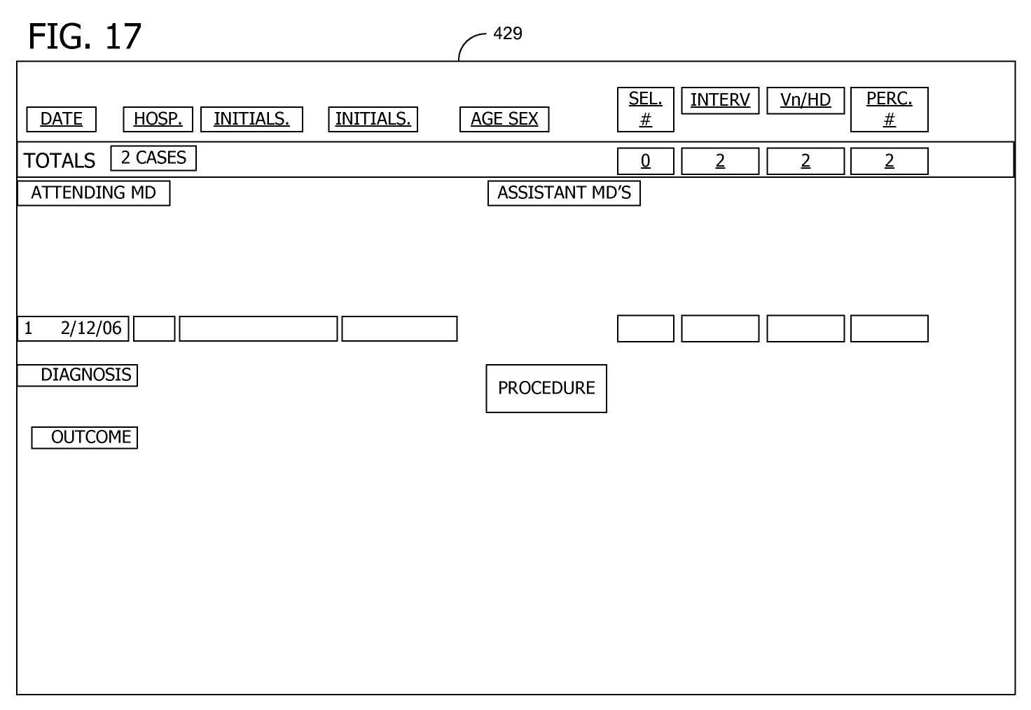

Turning to FIG. 17, the patient-specific user interface 41 includes a post-procedure listing of outcomes and complications 429, as generated by the outcomes and complications search interface 425 of the search sub-interface 411. Such a listing of outcomes and complications 429 is particularly relevant in reviewing outcomes and complications, such as for an M&M (morbidity and mortality) conference, whereby a user and peers may review M&M data relating to procedures stored in the memory area 35. Such M&M reporting is often utilized in the education of physicians and must be culled manually from patient charts. As discussed above, several user interfaces 281B-D of the patient-specific user interface 41 collect information relating to outcomes and complications. This information may be collected at the time of occurrence, and readily searched with the outcomes and complications search interface 425 and reviewed with the listing of outcomes and complications 429.

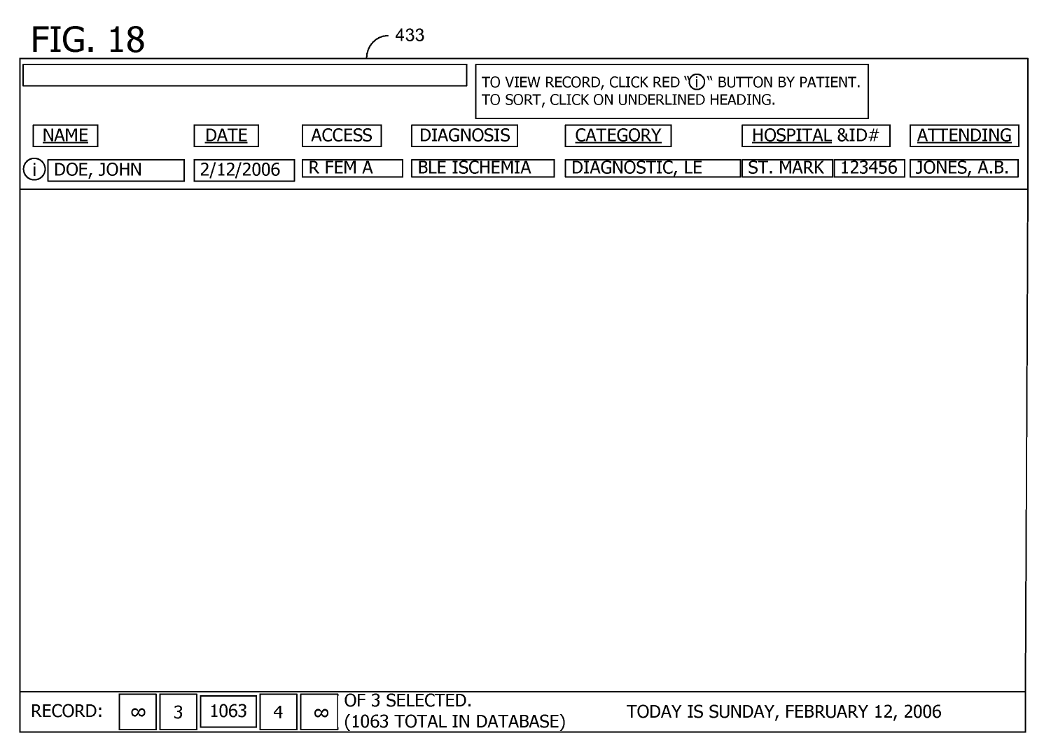

Referring to FIG. 18, the patient-specific user interface 41 also includes a tabular listing of patient procedures 433 as generated by the search sub-interface 411. In one example, such a listing of patient procedures 433 can include all of the patient procedures stored in the memory area 35. Each row comprises a particular patient procedure, while each column includes a data value for a different data category. In use, the user can readily scroll through the list of patients and their procedures to find a particular procedure or patient. Moreover, the user may sort the rows by selecting a particular column heading, such as name, date, access, diagnosis, category, hospital, hospital ID, and attending physician, among others. In this manner, the user may sort the various procedures by a specific column, whereby the procedures are grouped according to the selected column.

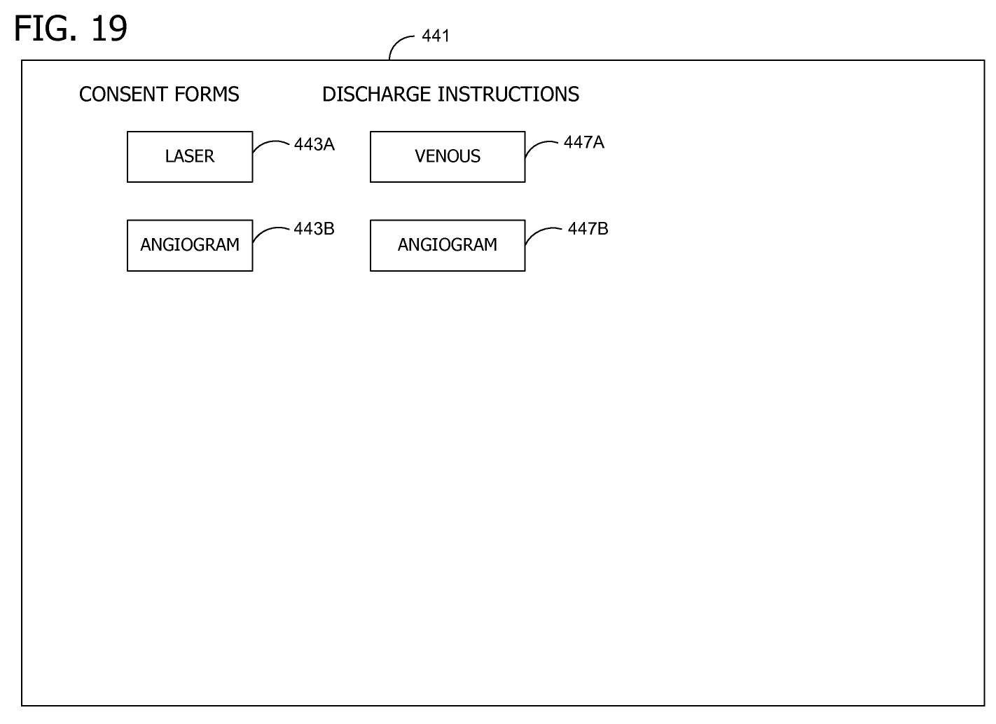

Turning to FIG. 19, the patient-specific user interface 41 further comprises a consent sub-interface 441 for automatically providing a specialized consent form as a function of the collected procedure-planning data for the planned medical procedures to memorialize patient consent for the planned one or more procedures. The consent sub-interface 441 automatically provides a procedure-dependent consent form tailored to the planned medical procedures. In the example shown, a laser consent selection element 443A adapted for providing a consent form associated with closure of a percutaneous piercing of the patient with a laser is shown. Similarly, an angiogram consent selection element 443B adapted for providing a consent form associated with performing an angiogram is shown. As would be readily understood by one skilled in the art, any number of other selection elements corresponding to particular consent forms may also be utilized without departing from the scope of embodiments of the invention. The consent sub-interface 441 further comprises discharge instructions selection elements 447 for automatically creating discharge instructions for patients after undergoing particular procedures. In the example shown, a venous discharge selection element 447A automatically provides discharge papers for a venous patient. Similarly, an angiogram discharge selection element 447B automatically provides discharge papers for an angiogram patient. As would be readily understood by one skilled in the art, any number of other selection elements 447 corresponding to particular discharge instructions may also be included without departing from the scope of embodiments of the invention.

Referring now to FIG. 20, the patient-specific user interface 41 further comprises a clinical sub-interface 51F of the invention. This portion of the user interface 41 is adapted for use in a clinical setting, such as for a post-procedure appointment with the attending physician. The clinical sub-interface 51F provides an overview of information relating to a particular patient, as well as mechanisms for adding additional data relating to the patient. The clinical sub-interface 51F includes a pictures selection element 451 adapted for saving images associated with a particular patient procedure. Selection of the pictures selection element 451 will prompt the user to browse and find images for storing such images in the memory area 35. An outcomes and complications selection element 453 and a wound care selection element 455 are also included for collection of outcomes and complications data and wound care data, respectively. Selection of either of these selection elements 453, 455 launches a corresponding user interface (not shown) comprising check boxes associated with specific medical outcomes and complications and wound care procedures, respectively, for collection of such information, as would be understood by one skilled in the art. The clinical sub-interface 51F also comprises a procedure display 457 for displaying any previous procedures associated with a particular patient (e.g. AO with runoff) and a follow-up display 459 for entry of any follow-up instructions regarding the patient.

Turning to FIG. 21, the atlas user interface 95 comprises a select store of medical information (e.g., images) related to the procedure-based medical practice. The example shown includes four subgroups of information accessible via associated selection elements, including a cerebral group selection element 465, an upper extremity group selection element 467, a lower extremity group selection element 469, and a visceral group selection element 471. Selection of a selection element 465, 467, 469, 471 associated with each of these subgroups provides the user with a portion of the atlas associated with the selection element. By integrating such an atlas into the patient-specific user interface 41, the user can readily access atlas information when the data is most needed, such as when the user is adding other procedural information to the memory area 35 via the previously discussed user interfaces. Other groups of images may also be included without departing from the scope of embodiments of the invention.

### Method for Managing Information in a Procedure-Based Medical Practice

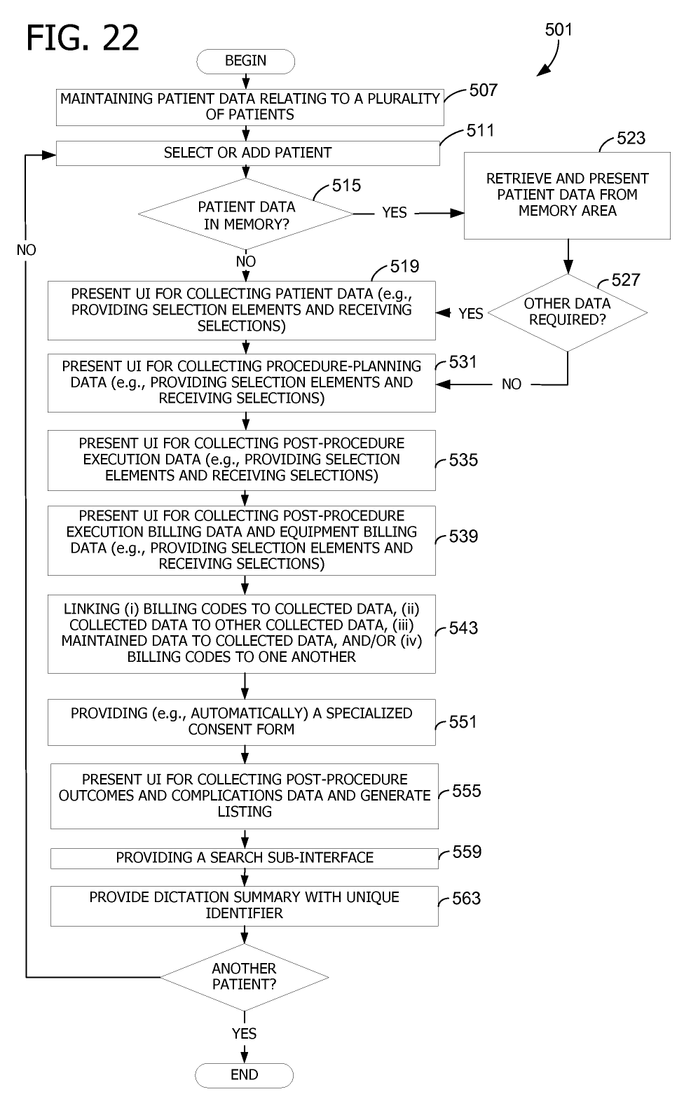

A computer-implemented method for managing information in a procedure-based medical practice is generally indicated at 501 in FIG. 22. The method comprises maintaining, at 507 patient data relating to a plurality of patients. The patient data represents patient identification and patient health information for each of the plurality of patients. In one example, the maintaining 507 patient data comprises maintaining at least one of patient identification information (e.g., name, age, date of birth, and gender), patient health information, patient medical history information (e.g., preexisting medical conditions,), patient vital statistics information (e.g., blood pressure, etc.), patient medication and allergy information (e.g., current medications, drug allergies, substance allergies), patient allergy information, patient physician information, patient referral data information, past patient medical procedure information (e.g., prior open surgeries, prior angioplasty, etc.), past patient study information (e.g., prior vascular studies). As would be understood by one skilled in the art, any type of patient data may be maintained without departing from the scope of embodiments of the invention.

The method 501 continues with the user selecting, at 511, an existing patient from the memory area 35 or adding, also at 511, a new patient to the memory area. The method then determines, at 515, if there is data relating to the patient in the memory area 35. Where there is no data relating to the patient in the memory area 35 (e.g., a new patient), the maintaining 507 of the method 501 presents, at 519, a patient-specific user interface for collecting patient data. Where there is data relating to the patient in the memory area 35, the maintaining 507 of the method 501 retrieves, at 523, the patient data from the memory area. Once the method 501 presents the retrieved data to the user, the user can determine, at 527, if other patient data needs to be entered before proceeding. Where the user determines that other patient data needs to be entered, the maintaining will present 519 a patient-specific user interface for collecting patient data, generally as set forth above when no data is present.

Once the data is retrieved and/or collected, the method further presents, at 531, a patient-specific user interface for collecting procedure-planning data. The procedure-planning data relates to one or more planned medical procedures for a selected one of the plurality of patients. In one embodiment, the presenting 531 a patient-specific user interface for collecting patient data comprises providing selection elements representing predetermined categories of patient data and receiving selections from a user via the patient-specific user interface. For example, the provided selection elements can relate to a particular medical specialty. In one example, the presenting 531 a patient-specific user interface for collecting procedure-planning data comprises providing selection elements representing predetermined categories of procedure-planning data and receiving selections from a user via the patient-specific user interface.

The method further presents, at 535, a patient-specific user interface for collecting post-procedure execution data. The post-procedure execution data relates to one or more of the planned medical procedures after being performed in the procedure-based medical practice. In one example, the presenting 535 a patient-specific user interface for collecting post-procedure execution data comprises collecting data relating to at least one of procedure duration, patient exposure time to procedural materials (e.g., fluoroscopy, x-rays, etc.), order of blood vessel selection, number of interventions, number of percutaneous operations, vessel runoff, number of lesions, and procedural subparts of the overall medical procedure.

The method further presents, at 539, a patient-specific user interface for collecting post-procedure execution billing data and post-procedure equipment billing data. Concerning the patient-specific user interface for collecting post-procedure execution billing data and post-procedure equipment billing data, the method may further comprise linking, at 543, billing codes associated with at least one of the post-procedure execution billing data and the post-procedure equipment billing data. In still another example, the method links 543 two or more procedural subparts, or billing codes, to one another. In this example, collection of post-procedure execution billing data with respect to one of the two or more procedural subparts, or billing codes, automatically selects the other of the two or more procedural subparts, or billing codes. For example, the linked two or more procedural subparts may comprise an interventional procedure and an interpretation procedure, among others.

In one example, the presenting 539 further provides selection elements representing predetermined categories post-procedure execution billing data and post-procedure equipment billing data and receiving selections from a user via the patient-specific user interface. These selection elements may be provided in any form, but in one example comprise displaying anatomical images 269 incorporating the selection elements 271 at anatomically representative locations of the anatomical images. In still another example, the providing selection elements also comprises displaying a billing code corresponding to each selection element 271. In yet another example, the displaying anatomical images 269 further comprises displaying color-coded anatomical images for better demonstrating to a user the locations of the selection elements at the anatomically representative locations.

The method 501 further comprises linking, also at 543, data between the maintained patient data and at least one of the collected procedure-planning data, the collected post-procedure execution data, the collected post-procedure equipment billing data, and the collected post-procedure execution billing data. In one example, this linking 543 occurs between the maintained patient data and each of the collected procedure-planning data, the collected post-procedure execution billing data, the collected post-procedure equipment billing data, and the post-procedure execution and equipment billing sub-interface. In this manner, the user need not key in common data repeatedly, which reduces data access time and minimizes keying errors.

The method 501 further comprises automatically providing, at 551, a specialized consent form as a function of the collected procedure-planning data for the planned medical procedures to memorialize patient consent for the planned one or more procedures. In one exemplary embodiment, automatically providing 551 a specialized consent form further comprises providing a procedure-dependent consent form tailored to the planned medical procedures.

The method 501 further comprises presenting, at 555, a patient-specific user interface for collecting post-procedure outcomes and complications data. The post-procedure outcomes and complications data relates to outcomes and complications arising from the one or more of the planned medical procedures after being performed in the procedure-based medical practice. In one example, the presenting 555 a patient-specific user interface for collecting post-procedure outcomes and complications data comprises collecting outcomes and complications data relating to outcomes and complications arising from the one or more of the planned medical procedures after being performed in the procedure-based medical practice. The presenting 555 a patient-specific user interface for collecting outcomes and complications data can also comprise providing selection elements representing predetermined categories of outcomes and complications data and receiving selections from a user via the patient-specific user interface. The method may further generate, also at 555, a post-procedure listing of performed medical procedures resulting in particular outcomes and complications.

In one embodiment of the invention, the method 501 further comprises providing, at 559, a search sub-interface for searching any of the collected data and for collecting a subset of the collected data for review by a user. In one example, the presenting 555 a patient-specific user interface for collecting outcomes and complications data can be combined with the providing 559 a search sub-interface.

The method 501 may further provide, at 563, a dictation identifier unique to a particular patient after the one or more of the planned medical procedures is performed in the procedure-based medical practice. The method 501 may further provide, also at 563, a dictation summary user interface for use in dictating information related to the collected data.

Those skilled in the art will note that the order of execution or performance of the methods illustrated and described herein is not essential, unless otherwise specified. That is, it is contemplated by the inventors that elements of the methods may be performed in any order, unless otherwise specified, and that the methods may include more or less elements than those disclosed herein.

When introducing elements of the present invention or the embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements.

As various changes could be made in the above products and methods without departing from the scope of the invention, it is intended that all matter contained in the above description and shown in the accompanying drawings shall be interpreted as illustrative and not in a limiting sense.

What is claimed is:

1. A computer-implemented method for managing information in a procedure-based medical practice, said method comprising:
maintaining patient data relating to a plurality of patients, said patient data representing patient identification and patient health information for each of the plurality of patients;
presenting a patient-specific user interface for collecting procedure-planning data, said procedure-planning data relating to one or more planned medical procedures for a selected one of the plurality of patients;
presenting a patient-specific user interface for collecting post-procedure execution data, said post-procedure execution data relating to one or more of the planned medical procedures after being performed in the procedure-based medical practice; and
presenting a patient-specific user interface for collecting post-procedure execution billing data and post-procedure equipment billing data.

2. The computer-implemented method of claim 1 wherein said maintaining patient data comprises at least one of presenting a patient-specific user interface for collecting patient data and retrieving patient data from a patient data memory area.

3. The computer-implemented method of claim 2 wherein said presenting a patient-specific user interface for collecting patient data comprises providing selection elements representing predetermined categories of patient data and receiving selections from a user via the patient-specific user interface.

4. The computer-implemented method of claim 3 wherein said providing selection elements further comprises providing selection elements relating to a particular medical specialty.

5. The computer-implemented method of claim 1 further comprising linking data between said maintained patient data and at least one of the collected procedure-planning data, the collected post-procedure execution data, the collected post-procedure equipment billing data, and the collected post-procedure execution billing data.

6. The computer-implemented method of claim 1 wherein said maintaining patient data comprises maintaining at least one of patient identification information, patient health information, patient medical history information, patient vital statistics information, patient medication information, patient allergy information, patient physician information, patient referral data information, past patient medical procedure information, and past patient study information.

7. The computer-implemented method of claim 1 wherein said presenting a patient-specific user interface for collecting procedure-planning data comprises providing selection elements representing predetermined categories of procedure-planning data and receiving selections from a user via the patient-specific user interface.

8. The computer-implemented method of claim 1 further comprising automatically providing a specialized consent form as a function of the collected procedure-planning data for the planned medical procedures to memorialize patient consent for the planned one or more procedures.

9. The computer-implemented method of claim 8 wherein said automatically providing a specialized consent form comprises providing a procedure-dependent consent form tailored to the planned medical procedures.

10. The computer-implemented method of claim 1 wherein said presenting a patient-specific user interface for collecting post-procedure execution data comprises collecting data relating to at least one of procedure duration, patient exposure time to procedural materials, order of blood vessel selection, number of interventions, number of percutaneous operations, vessel runoff, number of lesions, and procedural subparts of the overall medical procedure.

11. The computer-implemented method of claim 1 wherein said presenting a patient-specific user interface for collecting post-procedure execution billing data and post-procedure equipment billing data comprises linking billing codes with at least one of the post-procedure execution billing data and the post-procedure equipment billing data.

12. The computer-implemented method of claim 11 further comprising linking two or more post-procedure execution billing codes to one another, whereby collecting post-procedure execution billing data with respect to one of the two or more codes automatically selects the other of the two or more codes.

13. The computer-implemented method of claim 12 wherein one of said linked codes corresponds to an interventional procedure and another of said two or more codes corresponds to an interpretation procedure.

14. The computer-implemented method of claim 11 wherein said presenting a patient-specific user interface for collecting post-procedure execution billing data and post-procedure equipment billing data comprises providing selection elements representing predetermined categories of post-procedure execution billing data and post-procedure equipment billing data and receiving selections from a user via the patient-specific user interface.

15. The computer-implemented method of claim 14 wherein said providing selection elements further comprises displaying anatomical images incorporating said selection elements at anatomically representative locations of said anatomical images.

16. The computer-implemented method of claim 15 wherein said providing selection elements further comprises displaying a billing code corresponding to each selection element.

17. The computer-implemented method of claim 15 wherein said displaying anatomical images further comprises displaying color-coded anatomical images for better demonstrating to a user the locations of the selection elements at the anatomically representative locations.

18. The computer-implemented method of claim 1 wherein said presenting a patient-specific user interface for collecting post-procedure execution billing data and post-procedure equipment billing data further comprises providing selection elements representing predetermined categories of execution billing data and equipment billing data and receiving selections from a user via the patient-specific user interface.

19. The computer-implemented method of claim 1 further comprising presenting a patient-specific user interface for collecting post-procedure outcomes and complications data, said post-procedure outcomes and complications data relating to outcomes and complications arising from the one or more of the planned medical procedures after being performed in the procedure-based medical practice.

20. The computer-implemented method of claim 19 wherein said presenting a patient-specific user interface for collecting post-procedure outcomes and complications data comprises collecting outcomes and complications data relating to particular outcomes and complications arising from the one or more of the planned medical procedures after being performed in the procedure-based medical practice.

21. The computer-implemented method of claim 20 wherein said presenting a patient-specific user interface for collecting outcomes and complications data comprises providing selection elements representing predetermined categories of outcomes and complications data and receiving selections from a user via the patient-specific user interface.

22. The computer-implemented method of claim 20 further comprising generating a post-procedure listing of performed medical procedures resulting in particular outcomes and complications.

23. The computer-implemented method of claim 1 further comprising providing a search sub-interface for searching any of the collected data and for collecting a subset of the collected data for review by a user.

24. The computer-implemented method of claim 1 further comprising providing at least one of a dictation identifier unique to a particular patient after the one or more of the planned medical procedures is performed in the procedure-based medical practice and a dictation summary user interface for use in dictating.

25. The computer-implemented method of claim 1 further comprising providing an atlas of medical information relating to the procedure-based medical practice.

26. A system for managing information in a procedure-based medical practice, said system comprising:
a memory area for maintaining patient data relating to a plurality of patients, said patient data representing patient identification and patient health information for each of the plurality of patients; and
a patient-specific user interface adapted for communicating with said memory area for collecting and providing data, said patient-specific user interface comprising user-selectable sub-interfaces, said user-selectable sub-interfaces comprising:
a patient data collection and retrieval sub-interface for collecting patient data, sending the collected data to the memory area for storage, and retrieving patient data from the memory area;
a procedure-planning sub-interface for collecting procedure-planning data and sending the collected data to the memory area for storage, said procedure-planning data relating to one or more planned medical procedures for a selected one of the plurality of patients; and
a post-procedure execution and equipment billing sub-interface for collecting post-procedure execution and equipment billing data and sending the collected data to the memory area for storage, said post-procedure execution and equipment billing data relating to one or more of the planned medical procedures after being performed in the procedure-based medical practice

27. The system of claim 26 wherein the patient data collection and retrieval sub-interface comprises selection elements representing predetermined categories of patient data for receiving selections from a user via the patient data collection and retrieval sub-interface.

28. The system of claim 26 wherein the procedure-planning sub-interface comprises selection elements representing predetermined categories of procedure-planning data for receiving selections from a user via the procedure-planning sub-interface.

29. The system of claim 26 wherein the patient-specific user interface further comprises a consent sub-interface for automatically providing a specialized consent form as a function of the collected procedure-planning data for the planned medical procedures to memorialize patient consent for the planned one or more procedures.

30. The system of claim 29 wherein the consent sub-interface automatically provides a procedure-dependent consent form tailored to the planned medical procedures.

31. The system of claim 26 wherein the post-procedure execution and equipment billing sub-interface collects information relating to procedural subparts of the overall medical procedure, said system further comprising data links between a billing code associated with a collected procedural subpart and the collected procedural subpart.

32. The system of claim 31 wherein the post-procedure execution and equipment billing sub-interface includes data links between groups of two or more related procedural subparts, whereby user selection of one of the two or more linked procedural subparts via the post-procedure execution and equipment billing sub-interface automatically selects the other of the two or more linked procedural subparts.

33. The system of claim 32 wherein one of said two or more procedural subparts is an interventional procedure and another of said two or more procedural subparts is an interpretation procedure.

34. The system of claim 31 wherein the post-procedure execution and equipment billing sub-interface comprises selection elements representing predetermined categories of procedural subparts of the overall procedure for receiving selections from a user via the post-procedure execution sub-interface.

35. The system of claim 34 wherein the post-procedure execution and equipment billing sub-interface displays anatomical images incorporating said selection elements at anatomically representative locations of said anatomical images.

36. The system of claim 35 wherein the post-procedure execution and equipment billing sub-interface displays billing codes corresponding to the respective procedures associated with the selection elements.

37. The system of claim 35 wherein the post-procedure execution and equipment billing sub-interface displays color-coded anatomical images for demonstrating to a user the locations of the selection elements at the anatomically representative locations.

38. The system of claim 26 wherein the post-procedure execution and equipment billing sub-interface comprises selection elements representing predetermined categories of equipment billing data for receiving selections from a user via the post-procedure equipment sub-interface.

39. The system of claim 26 wherein the patient-specific user interface further comprises a user-selectable post-procedure outcomes and complications sub-interface for collecting post-procedure outcomes and complications data relating to outcomes and complications arising from the one or more of the planned medical procedures after being performed in the procedure-based medical practice.

40. The system of claim 39 wherein the post-procedure outcomes and complications sub-interface collects outcomes and complications data relating to particular outcomes and complications arising from the one or more of the planned medical procedures after being performed in the procedure-based medical practice and generates a post-procedure listing of performed medical procedures resulting in particular outcomes and complications.

41. The system of claim 26 further comprising a search sub-interface adapted for communication with the memory area for searching any of the collected data and for collecting a subset of the collected data for review by a user.

42. The system of claim 26 further comprising a processor adapted for accessing, maintaining, and modifying the data stored in the memory area and for displaying the patient-specific user interface for one or more users.

43. A patient-specific user interface for managing information in a procedure-based medical practice, said patient-specific user interface comprising user-selectable sub-interfaces, said user-selectable sub-interfaces comprising:
a patient data collection and retrieval sub-interface for collecting patient data and retrieving patient data from a memory area;
a procedure-planning sub-interface for collecting procedure-planning data, said procedure-planning data relating to one or more planned medical procedures for a selected one of the plurality of patients; and
a post-procedure execution and equipment billing sub-interface for collecting post-procedure execution and equipment billing data, said post-procedure execution and equipment billing data relating to one or more of the planned medical procedures after being performed in the procedure-based medical practice.
